(19) United States
(12) Patent Application Publication
(10) Pub. No.: US 2010/0074138 A1
(43) Pub. Date: Mar. 25, 2010

(54) TELEPHONE APPARATUS, COMMUNICATION SYSTEM, AND COMPUTER PROGRAM

(75) Inventors: Yasushi Hara, Kawasaki (JP); Shinichi Shiotsu, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/629,412

(22) Filed: Dec. 2, 2009

Related U.S. Application Data
(63) Continuation of application No. PCT/JP2007/065176, filed on Aug. 2, 2007.

(51) Int. Cl. H04J 1/16; H04L 12/66

(52) U.S. Cl. 370/252; 370/352

(57) ABSTRACT

There is provided a telephone apparatus for communicating with a different telephone apparatus via a network, including a telephone apparatus table in which first use type information indicating a type of use preset for the telephone apparatus is registered in association with telephone apparatus information identifying the telephone apparatus, a position table in which second use type information indicating the type of use preset for a position of the telephone apparatus is registered in association with the position, a position detection part detecting a present position of the telephone apparatus of concern, and a sensing part sensing an incoming call from the different telephone apparatus, a detection part detecting a telephone apparatus on a calling side when the sensing part senses the incoming call.

This application is a continuation, filed under 35 U.S.C. §111(a), of PCT International Application No. PCT/JP2007/065176 which has an international filing date of Aug. 2, 2007, and designated the United States of America.

### FIELD

The embodiments discussed herein relate to a telephone apparatus performing communication with a different telephone apparatus via a network, a communication system in which a control apparatus controls the communication between the telephone apparatuses, and a computer program for implementing an operation of the telephone apparatus by means of a computer.

### BACKGROUND

An IP telephone allowing transmission/reception of a packet via an IP network has been prevalent. Together with a call control server provided in, e.g., a corporate Local Area Network (LAN) constructed in a company and a wireless access point, the IP telephone constitutes an IP telephone system. In the IP telephone system mentioned above, the IP telephone may perform transmission/reception of the packet with a different IP telephone via the wireless access point and the corporate LAN. In addition, the corporate LAN is connected to, e.g., the Internet, and the IP telephone may also perform the transmission/reception of the packet with an IP telephone outside the company via the corporate LAN and the Internet.

In the IP telephone system mentioned above, when an incoming call arrives from the IP telephone in the company via the corporate LAN, or when an incoming call arrives from the IP telephone outside the company via the corporate LAN and the Internet, the call control server detects a telephone number of the IP telephone on a calling side and a telephone number of the IP telephone on a called side, and reports the presence of the incoming call to the IP telephone on the called side. With this operation, the IP telephone on the called side outputs a ring tone to report the presence of the incoming call to an owner. When the owner of the IP telephone on the called side answers the incoming call, the call control server establishes a connection between the IP telephone on the called side and the IP telephone on the calling side. This allows the transmission/reception of the packet between the IP telephone on the called side and the IP telephone on the calling side.

The IP telephone system has a call pick-up function in which a plurality of IP telephones are registered for each group and, when an incoming call arrives at one IP telephone, a different IP telephone in the same group may answer the incoming call. In the call pick-up function, when the different IP telephone belonging to the same group answers the incoming call in a state where the incoming call is at the one IP telephone, the call control server establishes the connection between the IP telephone that has answered the incoming call and the IP telephone on the calling side. This allows the transmission/reception of the packet between the IP telephone that has answered the incoming call and the IP telephone on the calling side. Accordingly, even when the owner of the IP telephone at which the incoming call has arrived may not answer the incoming call, the incoming call may be reliably answered by another user in the group, and operating effectiveness may be improved.

When the above-described call pick-up function is used, each owner of the IP telephone in the group needs to recognize the presence of the incoming call to another IP telephone in the group. Specifically, when the owner is not able to answer the incoming call to his or her IP telephone such as a case where the owner of the IP telephone outputting the ring tone on a desk is not at the desk, each owner needs to recognize the presence of the incoming call to the IP telephone which the owner is not able to answer. However, for example, when a manner mode is set in the IP telephone so that the ring tone is not outputted, the presence of the incoming call to the IP telephone which the owner thereof is not able to answer may not be recognized and the incoming call may not be answered from other IP telephones.

Consequently, Patent Document 1 discusses an apparatus which reports the presence of an incoming call by displaying it on a preset display apparatus when the incoming call arrives at a telephone. The use of such an apparatus allows an owner of the telephone to recognize the presence of the incoming call to the telephone thereof even when the owner views a picture using the display apparatus in a room different from a room where the telephone is placed. In addition, even when the owner of the telephone does not view the picture using the display apparatus, other viewers viewing the picture may recognize the presence or absence of the incoming call.

Further, Patent Document 2 discusses a system in which a personal computer is connected to a telephone apparatus, and information on a calling party is shown on a display of the personal computer when an incoming call arrives at the telephone apparatus. The use of such a system allows a user working with the personal computer to reliably recognize the presence of the incoming call to the telephone apparatus.

### [Patent Document 1] Japanese Laid-Open Patent Publication No. 2006-217499

### [Patent Document 2] Japanese Laid-Open Patent Publication No. 2001-223782

### SUMMARY

There is provided a telephone apparatus according to an aspect, for communicating with a different telephone apparatus via a network, comprising: a telephone apparatus table in which first use type information indicating a type of use preset for the telephone apparatus is registered in association with telephone apparatus information identifying the telephone apparatus; a position table in which second use type information indicating the type of use preset for a position of the telephone apparatus is registered in association with the position; a position detection part detecting a present position of the telephone apparatus of concern; a sensing part sensing an incoming call from the different telephone apparatus via the network; a detection part detecting a telephone apparatus on a calling side when the sensing part senses the incoming call; a first acquisition part acquiring the first use type information on the telephone apparatus on the calling side detected by the detection part from the telephone apparatus table; a second acquisition part acquiring the second use type information on the present position detected by the position detection part from the position table when the sensing part senses the incoming call; a determination part determining whether or not presence of the incoming call from the telephone apparatus on the calling side is reported to a given communication apparatus on a basis of the first use type information acquired by the first acquisition part and the second use type information acquired by the second acquisition part; and a report part reporting the presence of the incoming call from the telephone apparatus on the calling side to the telephone apparatus of concern to the given communication apparatus when the determination part determines that the presence of the incoming call is reported to the given communication apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic view illustrating an example of a structure of a communication system including a portable telephone according to a first embodiment;

FIG. 2 is a block diagram illustrating an example of a structure of the portable telephone according to the first embodiment;

FIG. 3 is a schematic view illustrating a registered content of a calling party table;

FIG. 4 is a schematic view illustrating a registered content of a position table;

FIG. 5 is a block diagram illustrating an example of a structure of a computer;

FIGS. 6A and 6B are schematic views each illustrating an example of a structure of a report screen;

FIG. 7 is an operation chart illustrating a procedure for report processing of an incoming call by the portable telephone;

FIG. 8 is an operation chart illustrating a procedure for report processing of the incoming call by the portable telephone;

FIG. 9 is an operation chart illustrating the procedure for the report processing of the incoming call by the portable telephone;

FIG. 10 is a schematic view illustrating an example of a structure of a communication system including a portable telephone according to a third embodiment;

FIGS. 11A to 11F are schematic views each for explaining an attitude of the portable telephone;

FIG. 12 is a schematic view illustrating a registered content of a calling party table;

FIG. 13 is a schematic view illustrating a registered content of a state table;

FIG. 14 is an operation chart illustrating a procedure for report processing of the incoming call by the portable telephone;

FIG. 15 is a schematic view illustrating a registered content of a calling party table;

FIG. 16 is an operation chart illustrating a procedure for report processing of the incoming call by the portable telephone;

FIG. 17 is a schematic view illustrating a registered content of a report destination table;

FIG. 18 is an operation chart illustrating a procedure for report processing of the incoming call by the portable telephone;

FIG. 19 is a schematic view illustrating an example of a structure of a call control server;

FIG. 20 is a schematic view illustrating a registered content of a report destination table;

FIG. 21 is an operation chart illustrating a procedure for report processing of the incoming call by the portable telephone;

FIG. 22 is a schematic view illustrating a registered content of a calling party table;

FIG. 23 is an operation chart illustrating a procedure for report processing of the incoming call by the portable telephone; and

FIG. 24 is an operation chart illustrating the procedure for the report processing of the incoming call by the portable telephone.

### DESCRIPTION OF EMBODIMENTS

### First Embodiment

In the apparatus which reports the presence of the incoming call by displaying it on the preset display apparatus when the incoming call arrives at the telephone, and in the system in which the personal computer is connected to the telephone apparatus, and the information on the calling party is shown on the display of the personal computer when the incoming call arrives at the telephone apparatus, the presence of the incoming call to the telephone may be reliably recognized. However, since the report of the presence of the incoming call is performed for every incoming call, there has been a problem that report processing of the incoming call, specifically, display processing to the display apparatus is increased. In particular, when the report of the incoming call is performed even though the owner of the telephone at which the incoming call has arrived is able to answer the incoming call, there has been a problem that unneeded display processing is increased.

In addition, for example, when a structure is adopted in which the presence of the incoming call is displayed on a monitor of the personal computer of another user, the unneeded display processing may interfere with the work of another user. Accordingly, there is a request that the presence of the incoming call be reported to the personal computer of another user only when the report to another user is necessary such as, e.g., a case where the owner of the telephone at which the incoming call has arrived is not able to answer the incoming call.

Further, in addition to a case where the telephone is used as a telephone for business use, there is considered a usage pattern in which the telephone is used as a telephone for private use. In such a usage pattern, when the report of the incoming call is performed for the income call from the telephone for private use, private information such as information on a calling party and a called party is reported to the personal computer of another user. Consequently, the private information is opened to another user and a problem is encountered that privacy may not be adequately protected.

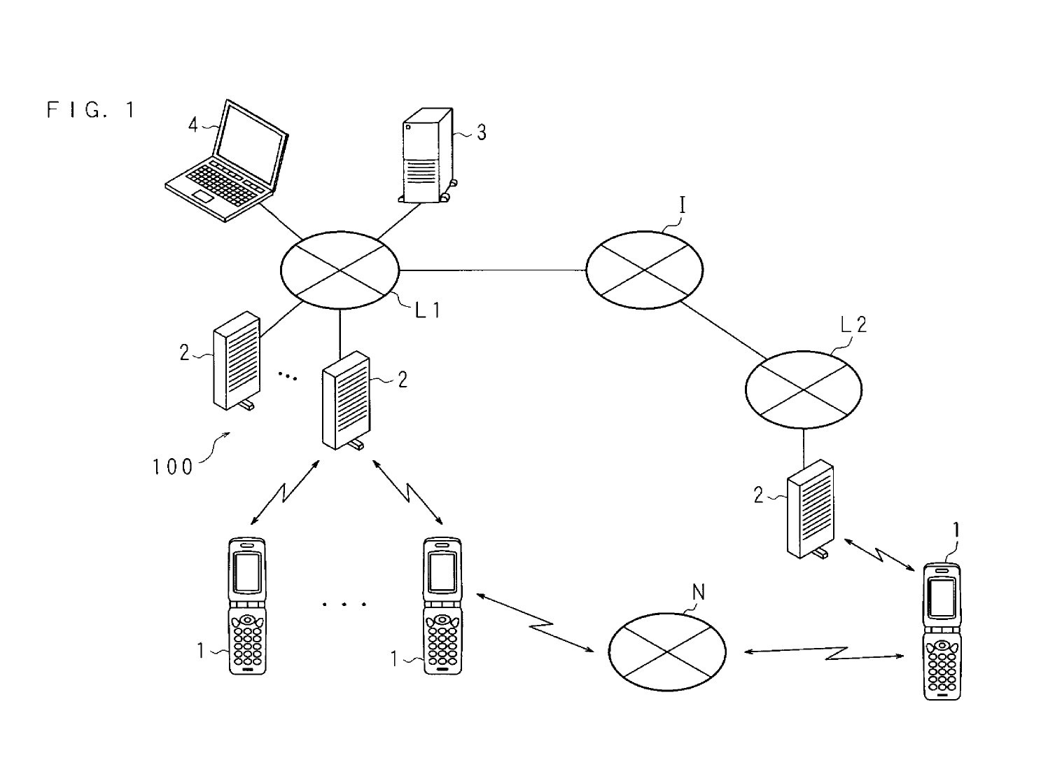

A detailed description will be given hereinbelow to a telephone apparatus on the basis of the drawings illustrating a portable telephone according to a first embodiment. FIG. 1 is a schematic view illustrating an example of a structure of a communication system including the portable telephone according to the first embodiment. A communication system 100 of the first embodiment is comprised of a network (IP network) L1 such as, e.g., a LAN, a call control server 3 connected to the network L1, a plurality of wireless access points (hereinbelow referred to as a wireless AP) 2, 2 . . . connected to the network L1, a computer 4 connected to the network L1, and portable telephones 1, 1 . . . performing communication with different portable telephones 1 via the network L1.

Although FIG. 1 illustrates the structure in which one computer 4 is connected to the network L1, a structure may also be adopted in which a plurality of computers 4 are connected to the network L1.

Each of the portable telephones 1 may perform wireless communication via the network L1, and performs the wireless communication with the nearest wireless AP 2. When the portable telephone 1 originates a call to a different portable telephone 1 via the wireless AP 2 and the network L1, the call control server 3 detects a telephone number of the portable telephone 1 on a calling side (calling party side) and a telephone number of the portable telephone 1 on a called side (called party side) on the basis of a packet received from the portable telephone 1 on the calling side. Subsequently, the call control server 3 sends the packet reporting presence of an incoming call from the portable telephone 1 on the calling side to the portable telephone 1 on the called side.

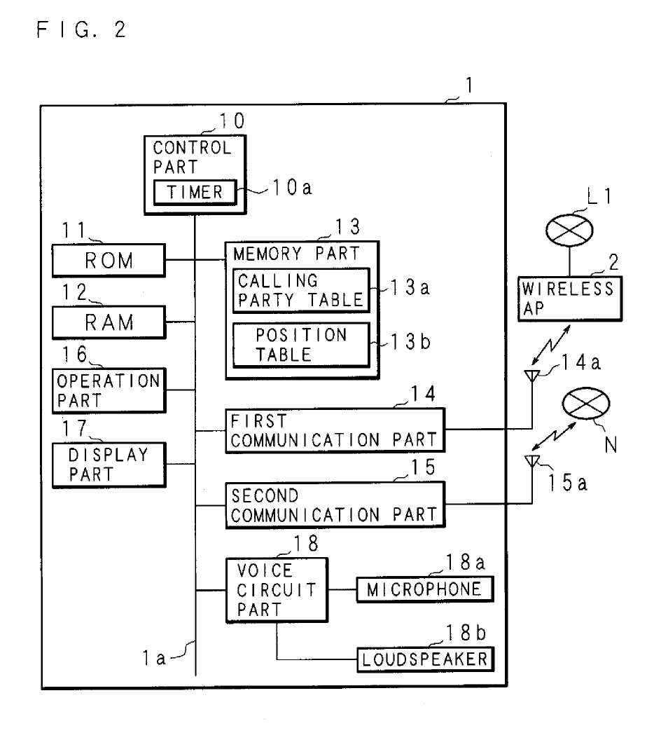

When receiving the packet reporting the presence of the incoming call from the portable telephone 1 on the calling side from the call control server 3, the portable telephone 1 on the called side sounds a ring tone and, at the same time, causes a display part 17 (see FIG. 2) to display the telephone number of the portable telephone 1 on the calling side. With this operation, the portable telephone 1 on the called side reports the presence of the incoming call to the owner thereof. When the presence of the incoming call is reported, the owner of the portable telephone 1 on the called side answers the incoming call by operating an operation part 16 (see FIG. 2). When the incoming call is answered by the portable telephone 1 on the called side, the call control server 3 establishes the connection between the portable telephone 1 on the calling side and the portable telephone 1 on the called side. This allows communication between the portable telephone 1 on the calling side and the portable telephone 1 on the called side.

In addition, the communication system 100 has a call pick-up function in which a plurality of portable telephones 1, 1, . . . are pre-registered for each group and, when the incoming call arrives at one portable telephone 1, a different portable telephone 1 in the same group may answer the incoming call. Specifically, the call control server 3 holds a group table in which telephone numbers of the portable telephones 1 belonging to the same group are registered for each group in a memory.

Subsequently, when the call control server 3 transmits the packet reporting the presence of the incoming call from the portable telephone 1 on the calling side to the portable telephone 1 on the called side, in a case where the incoming call is answered by a different portable telephone 1 belonging to the same group, the call control server 3 establishes the connection between the portable telephone 1 that has answered the incoming call and the portable telephone 1 on the calling side. With this operation, even when the owner of the portable telephone 1 on the called side is not able to answer, the pre-registered different user in the same group may reliably answer the incoming call. Consequently, operating effectiveness may be improved.

When the connection between the portable telephone 1 which is not the portable telephone 1 at which the incoming call has arrived and the portable telephone 1 on the calling side is established using the call pick-up function, the call control server 3 transmits the packet which indicates that the different portable telephone 1 has answered the incoming call to the portable telephone 1 at which the incoming call has arrived. With this operation, a control part 10 of the portable telephone 1 detects that a necessity to answer the incoming call is obviated to end the sounding of the ring tone and the displaying of the telephone number of the portable telephone 1 on the calling side on the display part 17.

The network L1 is connected to the Internet I, and is connected to another network L2 connected to the Internet I via the Internet I. Accordingly, the portable telephone 1 may perform communication via the Internet I with the portable telephone 1 which performs wireless communication via the another network L2. Also in this case, the call control server 3 detects the telephone number of the portable telephone 1 on the calling side and the telephone number of the portable telephone 1 on the called side on the basis of the packet received from the portable telephone 1 that has originated the call via the network L1 and the Internet I, and sends the packet reporting the presence of the incoming call from the portable telephone 1 on the calling side to the portable telephone 1 on the called side.

The portable telephone 1 of the first embodiment is structured to be capable of performing not only communication via the IP network including the network L1, the Internet I, and the network L2 but also communication via a public telephone network N such as, e.g., the FOMA network. Each of the portable telephones 1, 1 . . . may perform wireless communication with the nearest wireless AP 2 present within a given range with the portable telephone 1 at its center. When the wireless AP 2 is not present within the given range, the portable telephone 1 may not perform communication via the network L1 since the portable telephone 1 is out of range of the network L1.

FIG. 2 is a block diagram illustrating an example of a structure of the portable telephone 1 according to the first embodiment. The portable telephone 1 of the first embodiment has the control part 10, a ROM 11, a RAM 12, a memory part 13, a first communication part 14, a second communication part 15, the operation part 16, the display part 17, and a voice circuit part 18, and the individual hardware parts are connected to each other via a bus 1a.

The control part 10 is comprised of a Central Processing Unit (CPU) or a Micro Processing Unit (MPU) each with a timer (measurement part) 10a incorporated therein, appropriately reads control programs pre-stored in the ROM 11 or the memory part 13 into the RAM 12 and executes the control programs in accordance with the timing measured in the timer 10a, and, at the same time, controls the operations of the individual hardware parts mentioned above. In the ROM 11, there are pre-stored various control programs required in order to cause the portable telephone 1 to operate as the telephone apparatus. The RAM 12 is comprised of an SRAM or a flash memory, and temporarily stores various data generated during the execution of the control programs by the control part 10.

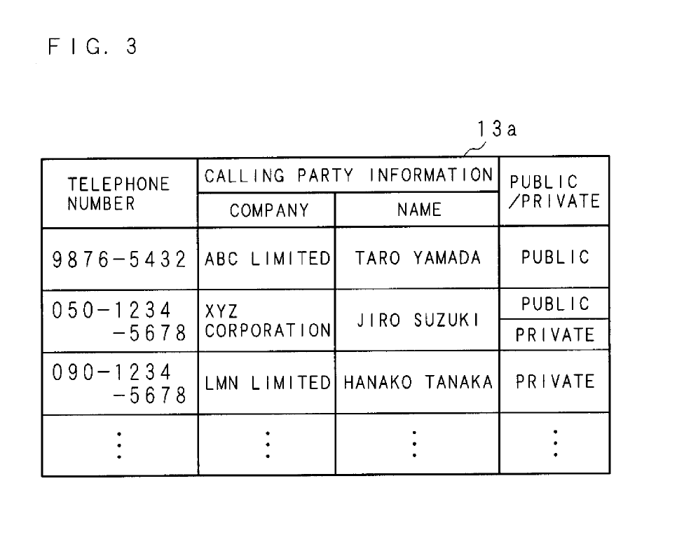

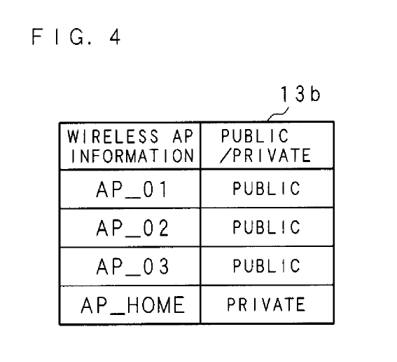

The memory part 13 is a nonvolatile memory such as the flash memory. In the memory part 13, there are pre-stored various control programs required in order to cause the portable telephone 1 to operate as the telephone apparatus, a calling party table 13a as illustrated in FIG. 3, a position table 13b as illustrated in FIG. 4, and a ring tone data (ringing melody). In addition, in the memory part 13, there are also stored the telephone number of the portable telephone 1 and the name of the owner of the portable telephone 1 as information related to the portable telephone 1 of concern.

In the calling party table (telephone apparatus table) 13a, as illustrated in FIG. 3, the telephone number of the portable telephone 1 owned by the calling party (telephone apparatus information), calling party information including the company name and the name of the calling party, and a distinction between public use and private use are registered in association with each other for each pre-registered calling party. In the section of the distinction between the public use and the private use, “public” is registered when the calling party is a business-related person, while “private” is registered when the calling party is a non-business-related person. Each time the information related to each calling party is added or modified via the operation part 16 by the owner of the portable telephone 1, the additional information is added to the registered content of the calling party table 13a or the registered content of the calling party table 13a is modified by the control part 10.

In the position table 13b, as illustrated in FIG. 4, wireless AP information for identifying the wireless APs 2, 2 . . . and the distinction between the public use and the private use are registered in association with each other for each of the wireless APs 2, 2 . . . connected to the network L1. In the section of the distinction between the public use and the private use, the “public” is registered when the wireless AP 2 is installed at a business-related location, while the “private” is registered when the wireless AP 2 is installed at a non-business-related location.

Accordingly, in the position table 13b, there is registered the information indicative of whether the installation location of each of the wireless APs 2, 2 . . . is the business-related location or the non-business-related location. Every time the information related to each wireless AP 2 is added or modified via the operation part 16 by the owner of the portable telephone 1, the additional information is added to the registered content of the position table 13b or the registered content of the position table 13b is modified by the control part 10.

It is to be noted that the information indicative of the distinction between the public use and the private use registered in the calling party table 13a and the information indicative of the distinction between the public use and the private use registered in the position table 13b are not limited to the “public” and the “private”, and therefore the information may be any information as long as the information indicates the type of use preset for each calling party (first use type information) and the type of use preset for each position (second use type information).

The first communication part 14 is connected to an antenna 14a for performing transmission/reception of radio waves for the wireless communication via the network L1, and establishes the connection with the nearest wireless AP 2 via the antenna 14a in accordance with the instruction from the control part 10. It is to be noted that, when the wireless AP 2 is not present within a given range with the portable telephone 1 at its center, the portable telephone 1 may not perform the communication via the network L1.

The second communication part 15 is connected to an antenna 15a for performing transmission/reception of radio waves for the wireless communication via the public telephone network N, and establishes the connection with the nearest base station (not shown) provided in the public telephone network N via the antenna 15a in accordance with the instruction from the control part 10. It is to be noted that, when the base station (access point) is not present within a given range with the portable telephone 1 at its center, the communication via the public telephone network N may not be performed since the portable telephone 1 is out of range of the public telephone network N.

The operation part 16 has various operation keys required for the owner of the portable telephone 1 to operate the portable telephone 1. When each of the operation keys is operated by the owner, the operation part 16 sends a control signal in correspondence to the operated operation key to the control part 10, and the control part 10 executes processing in correspondence to the acquired control signal.

The display part 17 is comprised of, e.g., a liquid crystal display (LCD), and displays the state of operation of the portable telephone 1, information inputted via the operation part 16, and information to be reported to the owner in accordance with the instruction from the control part 10.

To the voice circuit part 18, a microphone 18a and a loudspeaker 18b are connected. The microphone 18a collects a voice spoken by a user (owner) when the portable telephone 1 is used as a telephone, and transmits the collected voice to the voice circuit part 18. The loudspeaker 18b outputs the ring tone and the sound from the calling party (destination) when the portable telephone 1 is used as a telephone.

The voice circuit part 18 has an A/D converter (not shown).

The voice circuit part 18 performs A/D conversion processing with respect to an analog voice signal obtained by collecting the voice using the microphone 18a to generate a digital voice signal, and sends the obtained digital voice signal to the first communication part 14 or the second communication part 15. Each of the first and second communication parts 14 and 15 converts the digital voice signal sent from the voice circuit part 18 into a voice packet, and transmits the obtained voice packet to the portable telephone 1 of a communication party via the antenna 14a or 15a.

In addition, the voice circuit part 18 causes the loudspeaker 18b to output the ring tone on the basis of ring tone data read from the memory part 13 in accordance with the instruction from the control part 10. The voice circuit part 18 also causes the loudspeaker 18b to output the sound on the basis of voice data received from the portable telephone 1 of the communication party using the first or second communication part 14 or 15 in accordance with the instruction from the control part 10.

Each of the first and second communication parts 14 and 15 has a D/A converter (not shown). Each of the first and second communication parts 14 and 15 converts the voice packet received from the network L1 or the public telephone network N into the digital voice signal, performs D/A processing with respect to the obtained digital voice signal to generate the analog voice signal, and sends the obtained analog voice signal to the voice circuit part 18.

With the above-described processing, the portable telephone 1 may perform the communication with the portable telephone 1 of the communication party via the network L1 and the public telephone network N. It is to be noted that the portable telephone 1 may also perform transmission/reception of a video packet generated by converting a video signal and a data packet generated by converting a data signal in addition to the voice packet.

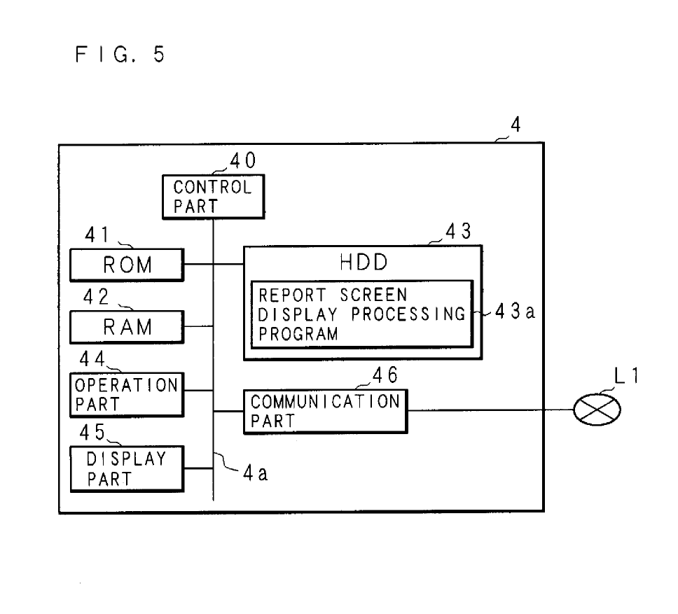

FIG. 5 is a block diagram illustrating an example of a structure of the computer 4. The computer 4 of the first embodiment is a known computer, and has a control part 40, a ROM 41, a RAM 42, a HDD 43, an operation part 44, a display part 45, and a communication part 46 for performing communication via the network L1. The individual hardware parts are connected to each other via a bus 4a.

The control part 40 is comprised of the CPU or the MPU, appropriately reads control programs pre-stored in the ROM 41 or the HDD 43 into the RAM 42 and executes the control programs, and, at the same time, controls the operations of the individual hardware parts mentioned above. In the ROM 41, various control programs required in order to cause the computer 4 to operate are pre-stored. The RAM 42 is comprised of the SRAM or the flash memory, and temporarily stores various data generated during the execution of the control programs by the control part 40.

The HDD 43 is a large-capacity storage apparatus. In the HDD 43, there are pre-stored various control programs executed by the control part 40, and a report screen display processing program 43a for displaying a given report screen when a given packet is received from the portable telephone 1.

The operation part 44 has various operation keys required for the user operating the computer 4 to operate the computer 4. When each of the operation keys is operated by the user, the operation part 44 sends the control signal in correspondence to the operated operation key to the control part 40, and the control part 40 executes the processing in correspondence to the acquired control signal.

The display part 45 is comprised of, e.g., the liquid crystal display or a CRT display, and displays the state of operation of the computer 4, information inputted via the operation part 44, and information to be reported to the user of the computer 4 in accordance with the instruction from the control part 40.

In the communication system 100 having the above-described structure, the control part 10 of the portable telephone 1 performs communication with the nearest wireless AP 2 via the first communication part 14 at given time intervals, and operates as a position detection part for detecting the present position of the portable telephone 1 using the installation location of the nearest wireless AP 2. The control part 10 sequentially updates and stores the wireless AP information for identifying the nearest wireless AP 2 in the memory part 13 every time the nearest wireless AP 2 is detected.

When receiving the packet reporting the presence of the incoming call from the call control server 3, the control part (sensing part) 10 of the portable telephone 1 senses the presence of the incoming call to the portable telephone 1 of the control part 10 from the different portable telephone 1 via the network L1. The packet reporting the presence of the incoming call includes the telephone number of the portable telephone 1 on the calling side, and the control part (detection part) 10 may detect (identify) the calling party by analyzing the packet received from the call control server 3.

In the portable telephone 1 of the first embodiment, when the control part 10 has identified the calling party, the control part 10 causes the ring tone to sound, and causes the display part 17 to display the display screen reporting the presence of the incoming call to report the presence of the incoming call to the owner. Simultaneously with this operation, the control part (first acquisition part) 10 acquires the distinction between the public use and the private use for the telephone number of the portable telephone 1 on the calling side from the calling party table 13a. In addition, the control part (second acquisition part) 10 acquires the distinction between the public use and the private use for the present nearest wireless AP 2 from the position table 13b on the basis of the wireless AP information stored in the memory part 13.

The control part (determination part) 10 determines whether or not the presence of the incoming call from this calling party is reported to the computer (given communication apparatus) 4 on the basis of the above-described distinction between the public use and the private use acquired from the calling party table 13a and the above-described distinction between the public use and the private use acquired from the position table 13b. When the distinction between the public use and the private use acquired from the calling party table 13a and the distinction between the public use and the private use acquired from the position table 13b indicate the same type of use, i.e., when the “public” is registered for the telephone number of the portable telephone 1 on the calling side in the calling party table 13a, and the “public” is registered for the present nearest wireless AP 2 in the position table 13b, or when the “private” is registered for the telephone number of the portable telephone 1 on the calling side in the calling party table 13a, and the “private” is registered for the present nearest wireless AP 2 in the position table 13b, the control part 10 determines that the presence of the incoming call from this calling party is reported to the computer 4.

Specifically, when the calling party is a business-related person, and the owner of the portable telephone 1 at which the incoming call has arrived is at a business-related location, i.e., when the incoming call from the telephone for business use arrives during working hours for the owner of the portable telephone 1, the presence of the incoming call is reported to the computer 4. On the other hand, when the calling party is a non-business-related person and the owner of the portable telephone 1 at which the incoming call has arrived is at a non-business-related location, i.e., when the incoming call from the telephone for private use arrives before or after working hours for the owner of the portable telephone 1, the presence of the incoming call is reported to the computer 4. Consequently, the presence or absence of the incoming call having a high need for response may be reported to the computer 4, and the presence or absence of the incoming call may be recognized not only by the owner of the portable telephone 1 but also by the user of the computer 4.

It is to be noted that, when the “public” is registered for the telephone number of the portable telephone 1 on the calling side in the calling party table 13a, and the “private” is registered for the present nearest wireless AP 2 in the position table 13b, or when the “private” is registered for the telephone number of the portable telephone 1 on the calling side in the calling party table 13a, and the “public” is registered for the present nearest wireless AP 2 in the position table 13b, it is determined that the presence of the incoming call from this calling party is not reported to the computer 4.

Specifically, when the incoming call from the telephone for private use arrives during working hours for the owner of the portable telephone 1, or when the incoming call from the telephone for business use arrives before or after working hours for the owner of the portable telephone 1, the presence of the incoming call is not reported to the computer 4. Consequently, by not reporting the incoming call having a low need for response to the computer 4, an increase in an execution frequency of the report processing of the incoming call to the computer 4 may be suppressed. This allows a reduction in the burden on the user of the computer 4 caused by performing the report processing of the incoming call to the computer 4.

Not only when the distinction between the public use and the private use (type of use) acquired from the calling party table 13a and the distinction between the public use and the private use (type of use) acquired from the position table 13b indicate the same type of use, but also when the type of use acquired from the calling party table 13a includes or included by the type of use acquired from the position table 13b, the control part 10 determines that the presence of the incoming call from the calling party is reported to the computer 4. Specifically, in a case where, for example, the “public”, the “private”, or “public and private” may be set in correspondence to the calling party or the present position of the called party instead of presetting either the “public” or the “private”, when the distinction between the public use and the private use acquired from the calling party table 13a indicates the “public”, and the distinction between the public use and the private use acquired from the position table 13b indicates the “public and private”, it is determined that the presence of the incoming call from the calling party is not reported to the computer 4.

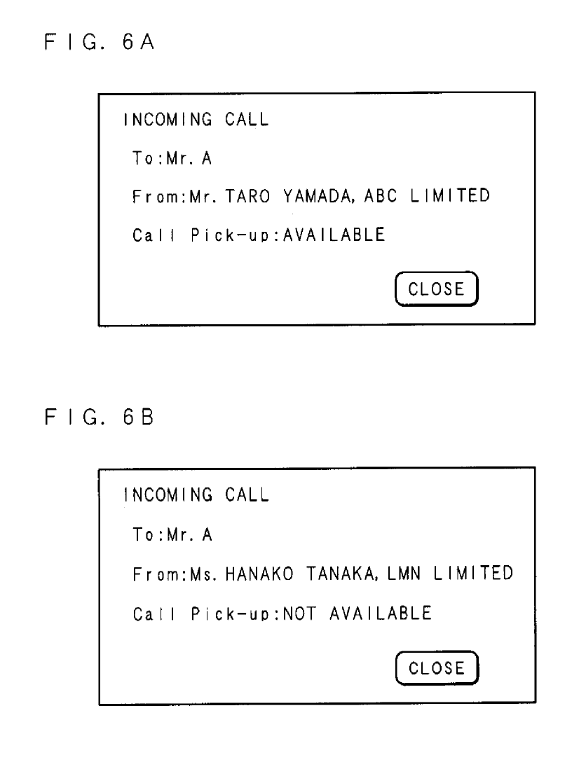

When determining that the presence of the incoming call from the calling party is reported to the computer 4, the control part 10 reads the calling party information from the calling party table 13a and, at the same time, reads the name of the owner of the portable telephone 1 of the control part 10 from the memory part 13. Subsequently, the control part 10 generates display data for causing the report screens as illustrated in FIGS. 6A and 6B to be displayed, and transmits the generated display data to the computer 4 via the first communication part (report part) 14.

When receiving the display data from the portable telephone 1, the control part 40 of the computer 4 reads the report screen display processing program 43a stored in the HDD 43 into the RAM 42, and sequentially executes the program 43a to cause the display part 45 to display the report screens as illustrated in FIGS. 6A and 6B. FIGS. 6A and 6B are schematic views each illustrating an example of the structure of each of the report screens. As illustrated in FIGS. 6A and 6B, each of the report screen displays the name of the called party, i.e., the name of the owner of the portable telephone 1 at which the incoming call has arrived, the name of the calling party, and information indicative of whether or not the incoming call may be answered by the different portable telephone 1 belonging to the same group using the call pick-up function.

The portable telephone 1 is structured to perform the processing of reporting the presence of the incoming call to the computer 4 as described above with respect to not only the incoming call via the network L1 but also the incoming call via the public telephone network N. However, since the call pick-up function is a function available in the communication via the network L1, the different portable telephone 1 may not answer the incoming call via the public telephone network N.

Accordingly, the control part 10 of the portable telephone 1 determines whether the incoming call is an incoming call via the network L1 or the incoming call via the public telephone network N on the basis of the telephone number of the portable telephone 1 on the calling side. Subsequently, in the case of the incoming call via the network L1, the control part 10 generates the display data for causing the report screen indicating the message “call pick-up available” as illustrated in FIG. 6A to be displayed. On the other hand, in the case of the incoming call via the public telephone network N, the control part 10 generates the display data for causing the report screen indicating the message “call pick-up unavailable” as illustrated in FIG. 6B to be displayed.

By causing the display part 45 of the computer 4 to display the report screen illustrated in FIG. 6A or 6B, the user of the computer 4 may recognize whose portable telephone 1 the incoming call has arrived at, and reliably cope with the incoming call. It is to be noted that, when the report screen illustrated in FIG. 6A is displayed on the display part 45 of the computer 4, the user of the computer 4 may answer the reported incoming call using the portable telephone 1 thereof. On the other hand, when the report screen illustrated in FIG. 6B is displayed on the display part 45 of the computer 4, the user of the computer 4 may inform the owner of the portable telephone 1 of the presence of the incoming call since the user may not answer the incoming call. In the report screens illustrated in FIGS. 6A and 6B, when the user of the computer 4 operates a Close button via the operation part 44, the control part 40 ends the display of the report screens.

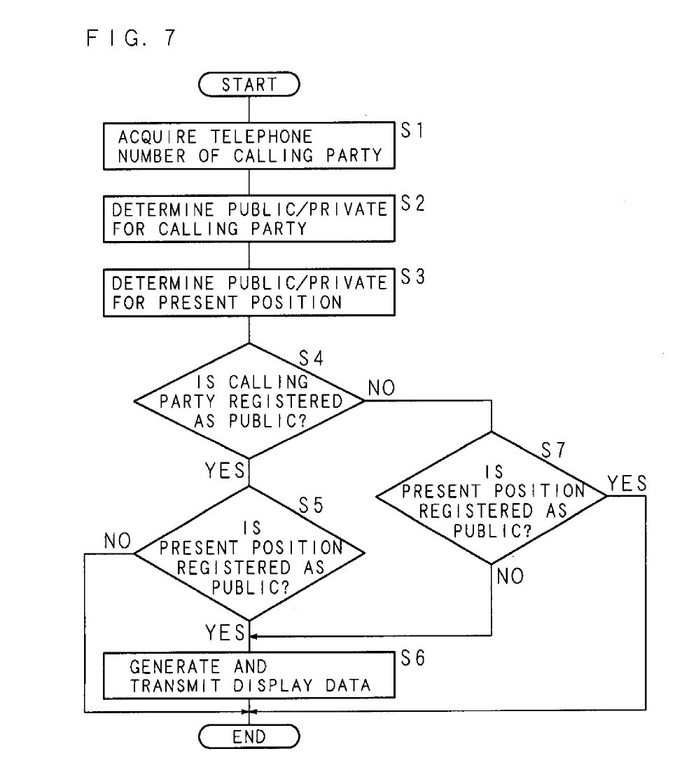

A description will be given hereinbelow to processing of reporting the incoming call to the portable telephone 1 to the computer 4 in the communication system 100 of the first embodiment on the basis of an operation chart. FIG. 7 is the operation chart illustrating the procedure for the report processing of the incoming call by the portable telephone 1. It is to be noted that the following processing is executed by the control part 10 in accordance with the control programs stored in the ROM 11 or the memory part 13 of the portable telephone 1.

When receiving the packet reporting the incoming call from the call control server 3 or from the base station provided in the public telephone network N, the control part 10 of the portable telephone 1 analyzes the received packet, and acquires the telephone number of the portable telephone 1 on the calling side (at S1). The control part 10 determines the distinction between the public use and the private use for the acquired telephone number, i.e., the distinction between the public use and the private use for the calling party on the basis of the registered content of the calling party table 13a (at S2).

The control part 10 determines the distinction between the public use and the private use for the present nearest wireless AP 2 indicated by the wireless AP information stored in the memory part 13, i.e., the distinction between the public use and the private use for the present position of the portable telephone 1 on the basis of the registered content of the position table 13b (at S3). In the determination processing in the operation at S2, the control part 10 determines whether or not the “public” is registered for the calling party in the calling party table 13a (at S4). When the “public” is registered (at S4: YES), the control part 10 determines whether or not the “public” is registered for the present position in the position table 13b in the determination processing in the operation at S3 (at S5).

When the “public” is registered for the present position (at S5: YES), i.e., when the “public” is registered for both of the calling party and the present position, the control part 10 generates the display data for reporting the presence of the incoming call to the portable telephone 1 thereof, transmits the generated display data to the computer 4 via the first communication part 14 (at S6), and ends the processing. When the “public” is not registered for the present position (at S5: NO), i.e., when the “public” is registered for the calling party, and the “private” is registered for the present position, the control part 10 ends the report processing of the incoming call described above.

In the operation at S4, when the “public” is not registered for the calling party in the calling party table 13a (at S4: NO), the control part 10 determines whether or not the “public” is registered for the present position in the position table 13b (at S7). When the “public” is registered for the present position (at S7: YES), i.e., when the “private” is registered for the calling party and the “public” is registered for the present position, the control part 10 ends the report processing of the incoming call described above.

In the operation at S7, when the “public” is not registered for the present position (at S7: NO), i.e., when the “private” is registered for both of the calling party and the present position, the control part 10 generates the display data for reporting the presence of the incoming call to the portable telephone 1 thereof, transmits the generated display data to the computer 4 via the first communication part 14 (at S6), and ends the processing.

As has been described above, in the computer 4 to which the display data is transmitted from the portable telephone 1 at which the incoming call has arrived, the control part 40 reads the report screen display processing program 43a stored in the HDD 43 into the RAM 42, and sequentially executes the program 43a to cause the display part 45 to display the report screens as illustrated in FIGS. 6A and 6B. With this operation, the presence of the incoming call to the portable telephone 1 may be reported to the user of the computer 4.

With the above-described processing, in the first embodiment, only when the incoming call from the telephone for business use arrives during working hours for the owner of the portable telephone 1, or when the incoming call from the telephone for private use arrives before or after working hours for the owner of the portable telephone 1, the presence of the incoming call is reported to the computer 4. Accordingly, the incoming call having a high need for response may be reliably recognized via the computer 4. In addition, by not reporting the incoming call having a low need for response to the user of the computer 4, an increase in the execution frequency of the report processing of the incoming call to the computer 4 may be suppressed, and the burden on the user of the computer 4 may be reduced.

In the first embodiment, the description has been given to the example where the telephone apparatus is applied to the portable telephone 1 structured to be capable of the communication via the IP network including the network L1, the Internet I, and the network L2, and the communication via the public telephone network N. However, the telephone apparatus according to the embodiment is not necessarily a Fixed Mobile Convergence (FMC) terminal, and may also be applied to the IP telephone capable of the communication via the IP network.

In addition, in the first embodiment, the description has been given to the communication system 100 having the structure in which the presence of the incoming call to the portable telephone 1 is reported to one computer 4. However, it will be easily appreciated that the presence of the incoming call to the portable telephone 1 may be reported to a plurality of computers 4, 4 . . . . In particular, when a structure is adopted in which the presence of the incoming call is reported to the computer 4 used by each of members of each group set to utilize the call pick-up function, since the incoming call may be answered by any of the users informed of the presence of the incoming call, operating effectiveness may be improved.

### Second Embodiment

A detailed description will be given hereinbelow to a telephone apparatus on the basis of the drawings illustrating a portable telephone according to a second embodiment. It is to be noted that, since the portable telephone of the second embodiment is implemented by adopting the same structure as that for the portable telephone 1 of the first embodiment illustrated in FIGS. 1 and 2, the description of the structure will be omitted. In the portable telephone 1 of the second embodiment, in addition to the individual constituent elements illustrated in FIG. 2, information indicative of whether or not a display timer is set is stored in the memory part 13.

The portable telephone 1 of the first embodiment described above is structured to report the presence of the incoming call to the computer 4 every time the incoming call via the network L1 or the public telephone network N arrives. In the case of such a structure, even in a situation where, e.g., the owner of the portable telephone 1 may answer the incoming call, the report processing to the computer 4 is performed so that unneeded report processing is frequently performed.

In view of the foregoing, the portable telephone 1 of the second embodiment has a display timer function which suspends the operation for a given period of time (for example, about 10 seconds) as a waiting time period between the sensing of the incoming call and the transmission of the display data for reporting the incoming call to the computer 4. The portable telephone 1 of the second embodiment is structured to be able to set whether or not the display timer function is executed using the setting by the owner and, every time the setting is changed by the owner, set information, specifically, information indicative of whether or not the display timer is set is updated and stored in the memory part 13.

In the communication system 100 of the second embodiment, similarly to the first embodiment, the control part 10 of the portable telephone 1 performs communication with the nearest wireless AP 2 at given time intervals via the first communication part 14, and sequentially updates and stores the wireless AP information identifying the nearest wireless AP 2 in the memory part 13 every time the nearest wireless AP 2 is detected.

When sensing the incoming call from the different portable telephone 1 via the network L1 or the public telephone network N, the control part 10 identifies the calling party and, at the same time, starts the measurement processing of a given period of time using the timer 10a. In addition, the control part 10 determines the distinction between the public use and the private use for the telephone number of the portable telephone 1 on the calling side on the basis of the registered content of the calling party table 13a and, at the same time, determines the distinction between the public use and the private use for the present nearest wireless AP 2 identified by the wireless AP information stored in the memory part 13 on the basis of the registered content of the position table 13b. When determining that the presence of the incoming call is reported to the computer 4 on the basis of the determination results mentioned above, the control part 10 generates the display data for causing the report screens as illustrated in FIGS. 6A and 6B to be displayed.

The control part 10 herein determines whether or not the display timer is set on the basis of the information stored in the memory part 13 and, when the display timer is not set, transmits the generated display data to the computer 4 via the first communication part 14. On the other hand, when the display timer is set, the control part 10 transmits the generated display data to the computer 4 via the first communication part 14 only when the incoming call is not answered yet after the given period of time is measured by the timer 10a. With this operation, the computer 4 may cause the display part 45 to display the report screens as illustrated in FIGS. 6A and 6B on the basis of the display data received from the portable telephone 1. It is to be noted that the control part 10 determines whether or not the incoming call is answered on the basis of the packet from the wireless AP 2 or the packet from the base station provided in the public telephone network N.

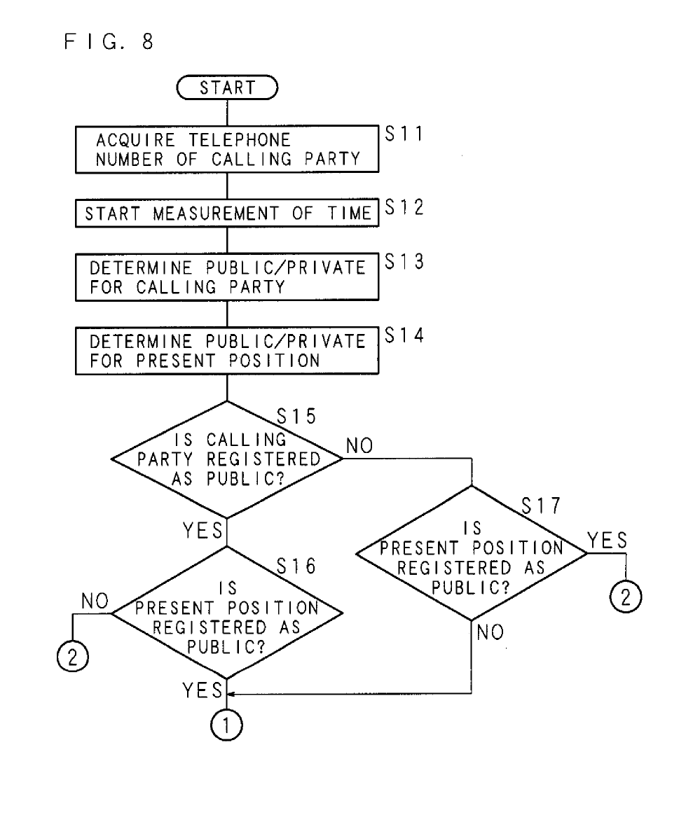

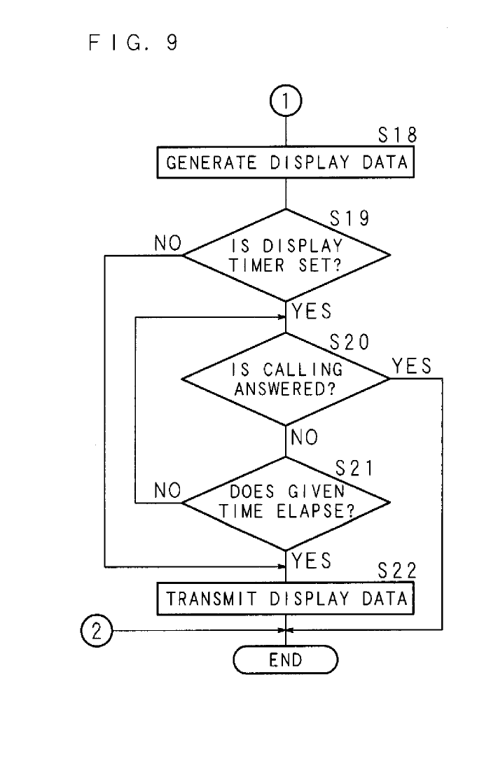

A description will be given hereinbelow to processing of reporting the incoming call to the portable telephone 1 to the computer 4 in the communication system 100 of the second embodiment on the basis of an operation chart. Each of FIGS. 8 and 9 is the operation chart illustrating the procedure for the report processing of the incoming call by the portable telephone 1. It is to be noted that the following processing is executed by the control part 10 in accordance with the control programs stored in the ROM 11 or the memory part 13 of the portable telephone 1.

When receiving the packet reporting the incoming call from the call control server 3, or from the base station provided in the public telephone network N, the control part 10 of the portable telephone 1 analyzes the received packet, and acquires the telephone number of the portable telephone 1 on the calling side (at S11). The control part 10 starts the measurement processing of the given period of time using the timer 10a thereof (at S12).

The control part 10 determines the distinction between the public use and the private use for the telephone number acquired in the operation at S11, i.e., the distinction between the public use and the private use for the calling party on the basis of the registered content of the calling party table 13a (at S13). In addition, the control part 10 determines the distinction between the public use and the private use for the present nearest wireless AP 2 indicated by the wireless AP information stored in the memory part 13, i.e., the distinction between the public use and the private use for the present position of the portable telephone 1 on the basis of the registered content of the position table 13b (at S14).

In the determination processing in the operation at S13, the control part 10 determines whether or not the “public” is registered for the calling party in the calling party table 13a (at 515) and, when the “public” is registered (at S15: YES), determines whether or not the “public” is registered for the present position in the position table 13b in the determination processing in the operation at S14 (at S16).

When the “public” is registered for the present position (at S16: YES), i.e., when the “public” is registered for both of the calling party and the present position, the control part 10 generates the display data for reporting the presence of the incoming call to the portable telephone 1 thereof (at S18), and moves the processing to the operation at S19. When the “public” is not registered for the present position (at S16: NO), i.e., when the “public” is registered for the calling party and the “private” is registered for the present position, the control part 10 ends the report processing of the incoming call described above.

In the operation at S15, when the “public” is not registered for the calling party in the calling party table 13a (at S15: NO), the control part 10 determines whether or not the “public” is registered for the present position in the position table 13b in the determination processing in the operation at S14 (at S17). When the “public” is registered for the present position (at S17: YES), i.e., when the “private” is registered for the calling party and the “public” is registered for the present position, the control part 10 ends the report processing of the incoming call described above.

In the operation at S17, when the “public” is not registered for the present position (at S17: NO), i.e., when the “private” is registered for both of the calling party and the present position, the control part 10 generates the display data for reporting the presence of the incoming call to the portable telephone 1 thereof (at S18), and moves the processing to the operation at S19.

The control part 10 determines whether or not the display timer is set on the basis of the information stored in the memory part 13 (at S19) and, when the control part 10 determines that the display timer is not set (at S19: NO), transmits the display data generated in the operation at S18 to the computer 4 via the first communication part 14 (at S22), and ends the processing.

When determining that the display timer is set (at S19: YES), the control part 10 determines whether or not the incoming call is answered in accordance with whether or not the packet reporting that the incoming call is answered is received from the call control server 3, or whether or not the packet reporting that the incoming call is answered is received from the base station provided in the public telephone network N (at S20). When determining that the incoming call is answered (at S20: YES), since it is no longer necessary to report the presence of the incoming call to the computer 4, the control part 10 ends the above-described processing.

When determining that the incoming call is not answered (at S20: NO), the control part 10 determines whether or not the given period of time has elapsed from the result of the measurement processing by the timer 10a (at S21) and, when the given period of time has not elapsed (at S21: NO), returns the processing to the operation at S20. When the given period of time has elapsed (at S21: YES), i.e., when the incoming call is not answered within the given period of time, the control part 10 transmits the display data generated in the operation at S18 to the computer 4 via the first communication part 14 (at S22), and ends the processing.

As has been described above, in the computer 4 to which the display data is transmitted from the portable telephone 1 at which the incoming call has arrived, the control part 40 reads the report screen display processing program 43a stored in the HDD 43 into the RAM 42, and sequentially executes the program 43a to cause the display part 45 to display the report screens as illustrated in FIGS. 6A and 6B. With this operation, the presence of the incoming call to the portable telephone 1 may be reported to the user of the computer 4.

With the above-described processing, in the second embodiment, when the incoming call arrives at the portable telephone 1, only in a case where the incoming call is not answered yet at the point when the given period of time has elapsed since the sensing of the incoming call by the portable telephone 1, the presence of the incoming call is reported to the computer 4. Accordingly, when the incoming call is answered by the owner of the portable telephone 1 or the owner of the different portable telephone 1 belonging to the same group within the given period of time since the sensing of the incoming call, the report processing to the computer 4 is not performed. Consequently, the occurrence of unneeded report processing may be suppressed.

### Third Embodiment

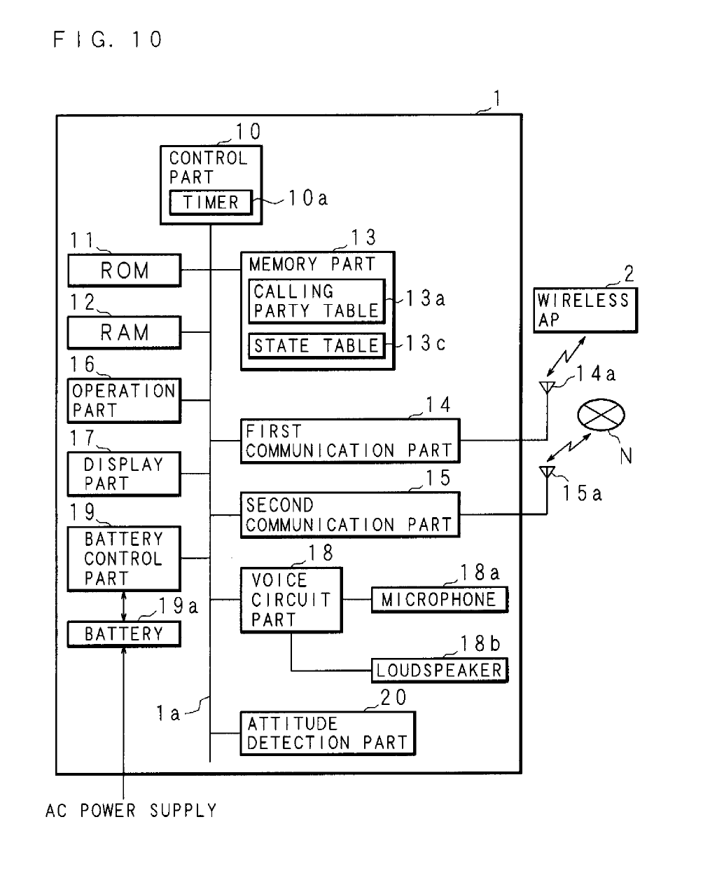

A detailed description will be given hereinbelow to a telephone apparatus on the basis of the drawings illustrating a portable telephone according to a third embodiment. FIG. 10 is a schematic view illustrating an example of a structure of a communication system including the portable telephone according to the third embodiment. It is to be noted that, since the communication system 100 of the third embodiment may be implemented by the individual apparatuses constituting the communication system 100 of the first embodiment, the description will be given on the assumption that the communication system 100 is comprised of the portable telephone 1, the wireless AP 2, the call control server 3, and the computer 4 each of the first embodiment.

The portable telephone 1 of the third embodiment has a battery control part 19 and an attitude detection part 20 in addition to the constituent elements illustrated in FIG. 2, and the battery control part 19 and the attitude detection part 20 are connected to the bus 1a. The battery control part 19 is connected to a power supply outlet (AC power supply) and a battery 19a, and supplies power supplied from the power supply outlet to the battery 19a to charge the battery 19a. In addition, the battery control part 19 supplies the power supplied from the power supply outlet or the battery 19a to the individual hardware parts constituting the portable telephone 1.

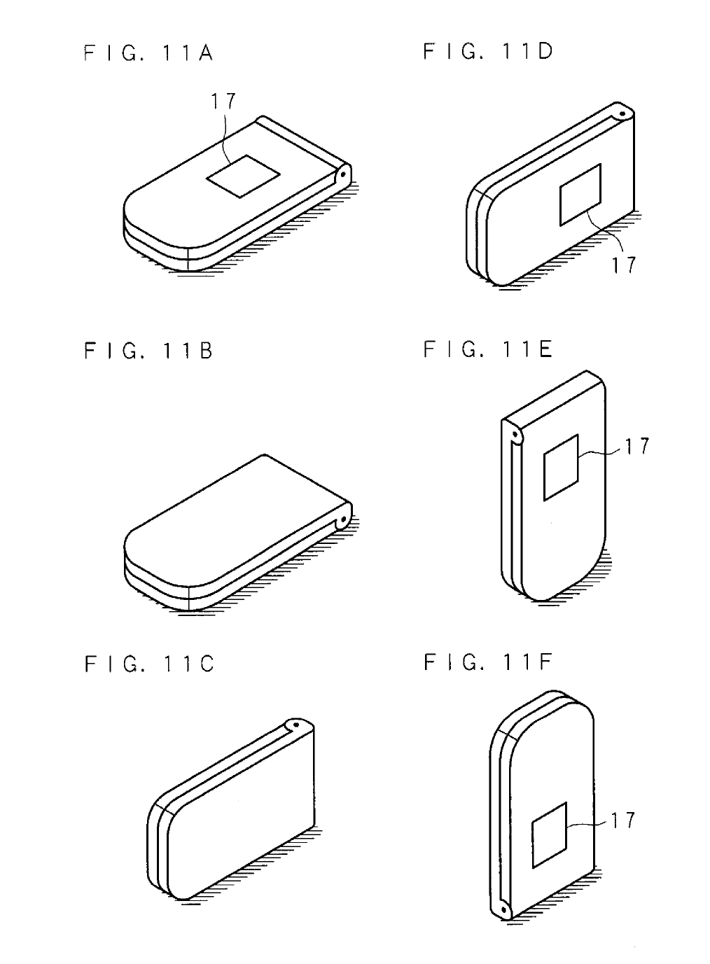

The attitude detection part 20 has, e.g., a gyro sensor, and detects the attitudes of the portable telephone 1. FIGS. 11A to 11F are schematic views each for explaining the attitude of the portable telephone 1. The attitudes of the portable telephone 1 mentioned herein indicate states illustrated in FIGS. 11A to 11F. Specifically, with regard to the portable telephone 1 having a rectangular parallelepiped shape which is a foldable portable telephone, as illustrated in FIG. 11A, a state in which the portable telephone 1 is placed on, e.g., a desk with its side surface provided with the display part 17 as an upper surface is assumed to be a state 1 and, as illustrated in FIG. 11B, a state in which the portable telephone 1 is placed on, e.g., the desk with its side surface provided with the display part 17 as a bottom surface is assumed to be a state 2.

In addition, as illustrated in FIG. 11C, a state in which the foldable portable telephone 1 is placed on, e.g., the desk with its side surface having, as one side thereof, the long side of the side surface provided with the display part 17 as the upper surface, a foldable portion of the foldable portable telephone 1 disposed on the right side in the drawing, and the side surface provided with the display part 17 directed in a right upward direction in the drawing, which corresponds to a backward direction when the drawing is viewed in three dimensions, is assumed to be a state 3. As illustrated in FIG. 11D, a state in which the foldable portable telephone 1 is placed on, e.g., the desk with its side surface having, as one side thereof, the long side of the side surface provided with the display part 17 as the upper surface, the foldable portion of the foldable portable telephone 1 disposed on the right side in the drawing, and the side surface provided with the display part 17 directed in a left downward direction in the drawing, which corresponds to a frontward direction when the drawing is viewed in three dimensions, is assumed to be a state 4.

Further, as illustrated in FIG. 11E, a state in which the foldable portable telephone 1 is placed, e.g., on the desk with its side surface which is the foldable portion of the foldable portable telephone 1 and has, as one side thereof, the short side of the side surface provided with the display part 17 as the upper surface is assumed to be a state 5. As illustrated in FIG. 11F, a state in which the foldable portable telephone 1 is placed, e.g., on the desk with its side surface which is the foldable portion of the foldable portable telephone 1 and has, as one side thereof, the short side of the side surface provided with the display part 17 as the bottom surface is assumed to be a state 6.

It is to be noted that the portable telephone 1 of the third embodiment is the foldable portable telephone, and is able to take each of the attitudes illustrated in FIGS. 11A to 11F. However, when a non-foldable portable telephone is used as the portable telephone 1, attitudes which the non-foldable portable telephone is able to take may be set.

The attitude detection part 20 detects not only the above-mentioned state of placement of the portable telephone 1 on the desk but also whether or not the battery control part 19 is charging the battery 19a with the power supplied from the power supply outlet. When the control part 10 receives the packet reporting the presence of the incoming call via the network L1 or the public telephone network N, and senses the presence of the incoming call to the portable telephone 1 thereof, the attitude detection part (state detection part) 20 detects the attitude of the portable telephone 1 and whether or not the battery 19a is being charged as mentioned above in accordance with the instruction from the control part 10.

The portable telephone 1 of the third embodiment has a manner mode function which does not sound the ring tone when the portable telephone 1 senses the incoming call. The portable telephone 1 is structured such that the setting of the execution of the manner mode function may be changed by the setting operation of the owner. Every time the setting is changed by the owner, set information, specifically, information indicative of whether or not the manner mode is set is updated and stored in the memory part 13.

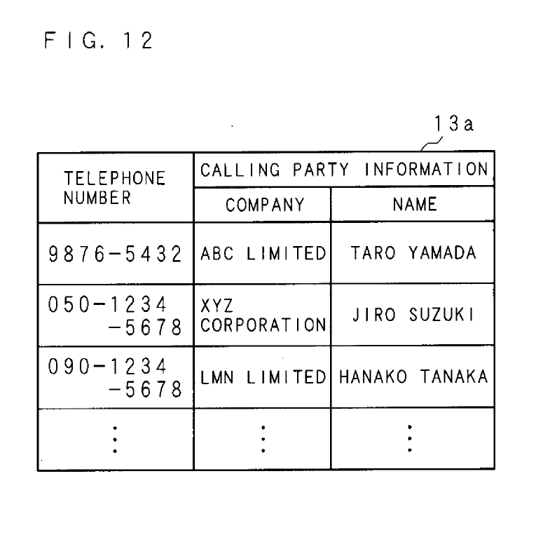

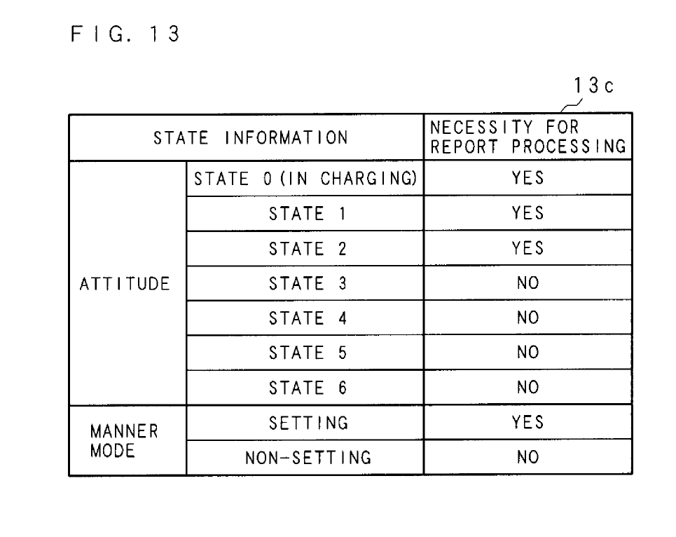

In addition, the portable telephone 1 of the third embodiment stores the calling party table 13a as illustrated in FIG. 12, and a state table 13c as illustrated in FIG. 13 in the memory part 13. In the calling party table 13a of the third embodiment, as illustrated in FIG. 12, the telephone number of the portable telephone 1 owned by the calling party and calling party information including a company name and the name of the calling party are registered in association with each other for each pre-registered calling party. Every time the information related to each calling party is added or modified by the owner of the portable telephone 1 via the operation part 16, the new information is added to the registered content of the calling party table 13a, or the registered content of the calling party table 13a is modified by the control part 10.

In the state table 13c, as illustrated in FIG. 13, state information and necessity for the report processing are registered in association with each other for each preset state of the portable telephone 1. The state information includes information related to the attitude of the portable telephone 1, and information related to the manner mode. The information related to the attitude of the portable telephone 1 includes a state in which the portable telephone 1 is being charged (state 0) and the above-mentioned attitudes of the portable telephone 1 (states 1 to 6). The information related to the manner mode includes setting and non-setting. In the section of the necessity for the report processing, there is registered the presence or absence of the necessity to perform the report processing to the computer 4 when the incoming call arrives in accordance with each state indicated by the state information. Every time the necessity for the report processing in correspondence to each state is set or modified by the owner of the portable telephone 1 via the operation part 16, the new setting is added to the registered content of the state table 13c, or the registered content of the state table 13c is modified by the control part 10.

In the communication system 100 of the third embodiment, similarly to the first and second embodiments, when sensing the incoming call from the different portable telephone 1 via the network L1 or the public telephone network N, the control part 10 of the portable telephone 1 identifies the calling party. Subsequently, the control part 10 detects which one of the above-mentioned states 0 to 6 the attitude of the portable telephone 1 corresponds to using the attitude detection part 20. In addition, the control part 10 detects the setting state of the manner mode, specifically, whether or not the manner mode is set on the basis of the information stored in the memory part 13.

The control part 10 determines the necessity for the report processing in correspondence to the detected attitude (states 0 to 6) of the portable telephone 1 and, at the same time, determines the necessity for the report processing in correspondence to the detected setting state of the manner mode on the basis of the registered content of the state table 13c. Subsequently, when the registered content in the state table 13c indicates that the report processing is necessary in accordance with the detected attitude of the portable telephone 1, and that the report processing is necessary in accordance with the detected setting state of the manner mode, the control part 10 determines that the presence of the incoming call is reported to the computer 4.

When determining that the presence of the incoming call is reported to the computer 4, the control part 10 reads the calling party information from the calling party table 13a and, at the same time, reads the name of the owner of the portable telephone 1 thereof from the memory part 13. Subsequently, the control part 10 generates the display data for causing the report screens as illustrated in FIGS. 6A and 6B to be displayed, and transmits the generated display data to the computer 4 via the first communication part 14. With this operation, the computer 4 may cause the display part 45 to display the report screens as illustrated in FIGS. 6A and 6B on the basis of the display data received from the portable telephone 1.

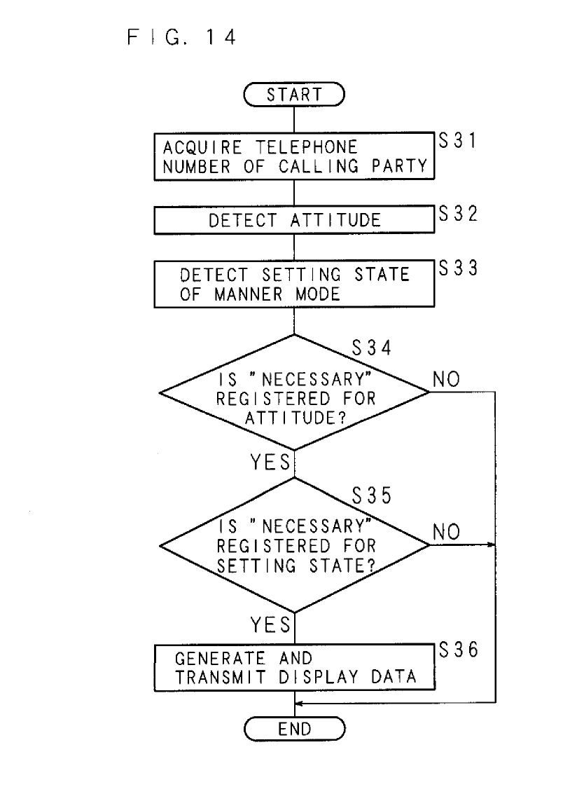

A description will be given hereinbelow to processing of reporting the incoming call to the portable telephone 1 to the computer 4 in the communication system 100 of the third embodiment on the basis of an operation chart. FIG. 14 is the operation chart illustrating the procedure for the report processing of the incoming call by the portable telephone 1. It is to be noted that the following processing is executed by the control part 10 in accordance with the control programs stored in the ROM 11 or the memory part 13 of the portable telephone 1.

When receiving the packet reporting the incoming call from the call control server 3 or from the base station provided in the public telephone network N, the control part 10 of the portable telephone 1 analyzes the received packet, and acquires the telephone number of the portable telephone 1 on the calling side (at S31). The control part 10 detects the attitude of the portable telephone 1 using the attitude detection part 20 (at S32). Specifically, the control part 10 detects whether or not the portable telephone 1 is being charged, and which one of the attitudes illustrated in FIGS. 11A to 11F the attitude of the portable telephone 1 corresponds to. The control part 10 detects the setting state of the manner mode on the basis of the information stored in the memory part 13 (at S33). Specifically, the control part 10 detects whether or not the manner mode is set.

The control part 10 determines whether or not “necessary” is registered in the state table 13c with regard to the necessity for the report processing in correspondence to the attitude detected in the operation at S32 (at S34) and, when the “necessary” is not registered (at S34: NO), i.e., when “not necessary” is registered, the control part 10 ends the report processing of the incoming call described above. When the “necessary” is registered for the attitude in the state table 13c (at S34: YES), the control part 10 determines whether or not the “necessary” is registered in the state table 13c with regard to the necessity for the report processing in correspondence to the setting state of the manner mode detected in the operation at S33 (at S35) and, when the “necessary” is not registered (at S35: NO), i.e., when the “not necessary” is registered, the control part 10 ends the report processing of the incoming call described above.

When the “necessary” is registered for the setting state of the manner mode in the state table 13c (at S35: YES), i.e., when the “necessary” is registered for both of the attitude and the setting state of the manner mode, the control part 10 generates the display data for reporting the presence of the incoming call to the portable telephone 1 thereof, transmits the generated display data to the computer 4 via the first communication part 14 (at S36), and ends the processing.

As has been described above, in the computer 4 to which the display data is transmitted from the portable telephone 1 at which the incoming call has arrived, the control part 40 reads the report screen display processing program 43a stored in the HDD 43 into the RAM 42, and sequentially executes the program 43a to cause the display part 45 to display the report screens as illustrated in FIGS. 6A and 6B. With this operation, the presence of the incoming call to the portable telephone 1 may be reported to the user of the computer 4.

With the above-described processing, only when the incoming call arrives in a state where the portable telephone 1 is being charged, or the portable telephone 1 is in the attitude in which the portable telephone 1 is likely to be unattended by the owner and the manner mode is set, the presence of the incoming call is reported to the computer 4. Accordingly, when the owner is unlikely to answer the incoming call, the presence of the incoming call may be reliably recognized via the computer 4. In addition, when the owner is likely to answer the incoming call, the presence of the incoming call is not reported to the computer 4. Consequently, an increase in an execution frequency of the report processing of the incoming call to the computer 4 may be suppressed, and the burden on the user of the computer 4 may be reduced.

In the third embodiment described above, the description has been given to the structure in which it is determined that the portable telephone 1 is likely to be unattended by the owner when the portable telephone 1 is being charged or when the portable telephone 1 is in the attitudes illustrated in FIGS. 11A and 11B on the basis of the registered content of the state table 13c illustrated in FIG. 13, and the report processing of the incoming call to the computer 4 is accordingly performed. However, a structure may also be adopted in which it is determined that the portable telephone 1 is likely to be unattended by the owner when, e.g., the portable telephone 1 continues to be in the same attitude for longer than a given period of time, and the report processing of the incoming call to the computer 4 is accordingly performed.

In this case, for example, the control part 10 of the portable telephone 1 detects the state of placement of the portable telephone 1 using the attitude detection part 20 at the intervals of a given period of time, and adds up the given period of time when the detected state of the placement remains the same as that at the previous detection. With this operation, a period of time when the portable telephone 1 continues to be in the same attitude may be measured. When the period of time measured in this manner becomes longer than a given period of time, it is determined that the portable telephone 1 is unattended, and the presence of the incoming call may be reported to the computer 4 in a case where the incoming call arrives when the portable telephone 1 is in the unattended state.

Similarly to the portable telephone 1 of the first embodiment, the portable telephone 1 of the third embodiment is structured to report the presence of the incoming call to the computer 4 every time the incoming call via the network L1 or the public telephone network N arrives. However, similarly to the portable telephone 1 of the second embodiment, the portable telephone 1 of the third embodiment may also be structured to suspend the operation for a given period of time (for example, about 10 seconds) as a waiting time period between the sensing of the incoming call and the transmission of the display data for reporting the incoming call to the computer 4. In this case, when the incoming call is answered by the owner of the portable telephone 1 or the owner of the different portable telephone 1 belonging to the same group within the given period of time since the sensing of the incoming call, the report processing to the computer 4 is not performed. Consequently, the occurrence of unneeded report processing may be suppressed.

In the third embodiment described above, the description has been given by taking, as an example, the portable telephone 1 structured to determine whether or not the presence of the incoming call is reported to the computer 4 in accordance with the state of the portable telephone 1 when the incoming call arrives. In each of the first and second embodiments, the description has been given by taking, as an example, the portable telephone 1 structured to determine whether or not the presence of the incoming call is reported to the computer 4 in accordance with the distinction between the public use and the private use preset for the calling party and the distinction between the public use and the private use preset for the present position of the portable telephone 1 when the incoming call arrives. However, the telephone apparatus according to the embodiment may also be applied to the portable telephone 1 having the structure in which the portable telephone 1 of the first embodiment is combined with the portable telephone 1 of the third embodiment.

Specifically, when determining that the report processing of the incoming call to the computer 4 is performed on the basis of the state of the portable telephone 1, the control part 10 of the portable telephone 1 determines whether or not the report processing of the incoming call to the computer 4 is performed on the basis of the distinction between the public use and the private use preset for the calling party and the distinction between the public use and the private use preset for the present position of the portable telephone 1. When herein determining that the report processing to the computer 4 is performed, the control part 10 may report the presence of the incoming call to the computer 4. It is to be noted that, since the processing of determining whether or not the report processing of the incoming call to the computer 4 is performed on the basis of the state of the portable telephone 1, and the processing of determining whether or not the report processing of the incoming call to the computer 4 is performed on the basis of the distinction between the public use and the private use preset for the calling party and the distinction between the public use and the private use preset for the present position of the portable telephone 1 are similar to the processing described in each of the first and third embodiments, the description of the details thereof will be omitted.

### Fourth Embodiment

A detailed description will be given hereinbelow to a telephone apparatus on the basis of the drawings illustrating a portable telephone according to a fourth embodiment. It is to be noted that, since the communication system 100 of the fourth embodiment may be implemented by the individual apparatuses constituting the communication system 100 of the first embodiment, the description will be given on the assumption that the communication system 100 is comprised of the portable telephone 1, the wireless AP 2, the call control server 3, and the computer 4 each of the first embodiment.

The portable telephone 1 of the first embodiment described above is structured to determine whether or not the presence of the incoming call is reported to the computer 4 by performing the given determination processing when the incoming call arrives, and generate the display data for causing the report screens as illustrated in FIGS. 6A and 6B to be displayed and transmit the generated display data to the given computer 4 when it is determined that the presence of the incoming call is reported to the computer 4.

The portable telephone 1 of the fourth embodiment is structured to be capable of reporting the presence of the incoming call to the computer 4 as a report destination in correspondence to the portable telephone 1 on the calling side, i.e., the calling party when it is determined that the presence of the incoming call is reported to the computer 4. Accordingly, the owner of the portable telephone 1 may recognize the presence or absence of the incoming call using a different computer 4 in accordance with the calling party.

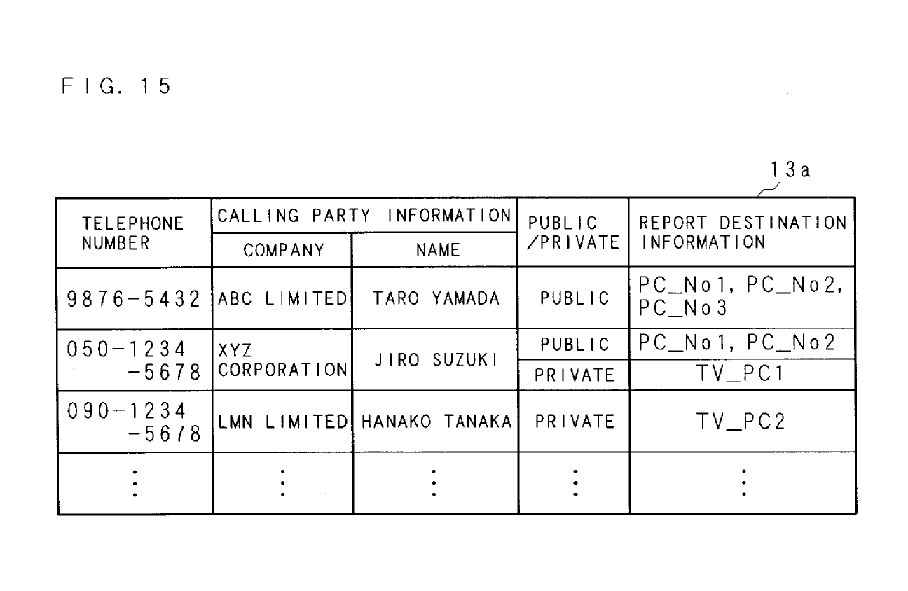

The portable telephone 1 of the fourth embodiment stores the calling party table 13a as illustrated in FIG. 15 in the memory part 13. In the calling party table (apparatus table) 13a, as illustrated in FIG. 15, the telephone number of the portable telephone 1 owned by the calling party (telephone apparatus information), the calling party information including the company name and the name of the calling party, the distinction between the public use and the private use, and report destination information (communication apparatus information) are registered in association with each other for each pre-registered calling party.

In the section of the report destination information, information on the communication destination is registered in correspondence to each of the “public” and the “private” registered in the section of the distinction between the public use and the private use set for each calling party. In the section of the report destination information, one communication destination may registered for each calling party and a plurality of communication destinations may also be registered for each calling party, and not only the computer 4 connected via the network L1 but also a computer connected via the Internet I may be registered as the communication destination. Every time the information related to each calling party is added or modified via the operation part 16 by the owner of the portable telephone 1, the additional information is added to the registered content of the calling party table 13a, or the registered content of the calling party table 13a is modified by the control part 10.

In the communication system 100 of the fourth embodiment, similarly to the first embodiment described above, the control part 10 of the portable telephone 1 performs communication with the nearest wireless AP 2 at given time intervals via the first communication part 14, and sequentially updates and stores the wireless AP information identifying the nearest wireless AP 2 in the memory part 13 every time the nearest wireless AP 2 is detected.

When sensing the incoming call from the different portable telephone 1 via the network L1 or the public telephone network N, the control part 10 identifies the calling party. In addition, the control part 10 determines the distinction between the public use and the private use for the telephone number of the portable telephone 1 on the calling side on the basis of the registered content of the calling party table 13a and, at the same time, determines the distinction between the public use and the private use for the present nearest wireless AP 2 identified by the wireless AP information stored in the memory part 13 on the basis of the registered content of the position table 13b. Subsequently, when determining that the presence of the incoming call is reported to the computer 4 on the basis of the determination results, the control part 10 generates the display data for causing the report screens as illustrated in FIGS. 6A and 6B to be displayed.

The control part 10 then reads the report destination information registered in correspondence to the telephone number of the portable telephone 1 on the calling side in the calling party table 13a, and transmits the display data to the computer 4 as the report destination indicated by the read report destination information via the first communication part 14. With this operation, the computer 4 may cause the display part 45 to display the report screens as illustrated in FIGS. 6A and 6B on the basis of the display data received from the portable telephone 1.

When the “public” is registered for the telephone number of the portable telephone 1 on the calling side in the calling party table 13a, and the “public” is registered for the present nearest wireless AP 2 in the position table 13b, the control part 10 reads the report destination information registered in correspondence to the “public” in the section of the distinction between the public use and the private use in the calling party table 13a. On the other hand, when the “private” is registered for the telephone number of the portable telephone 1 on the calling side in the calling party table 13a, and the “private” is registered for the present nearest wireless AP 2 in the position table 13b, the control part 10 reads the report destination information registered in correspondence to the “private” in the section of the distinction between the public use and the private use in the calling party table 13a.

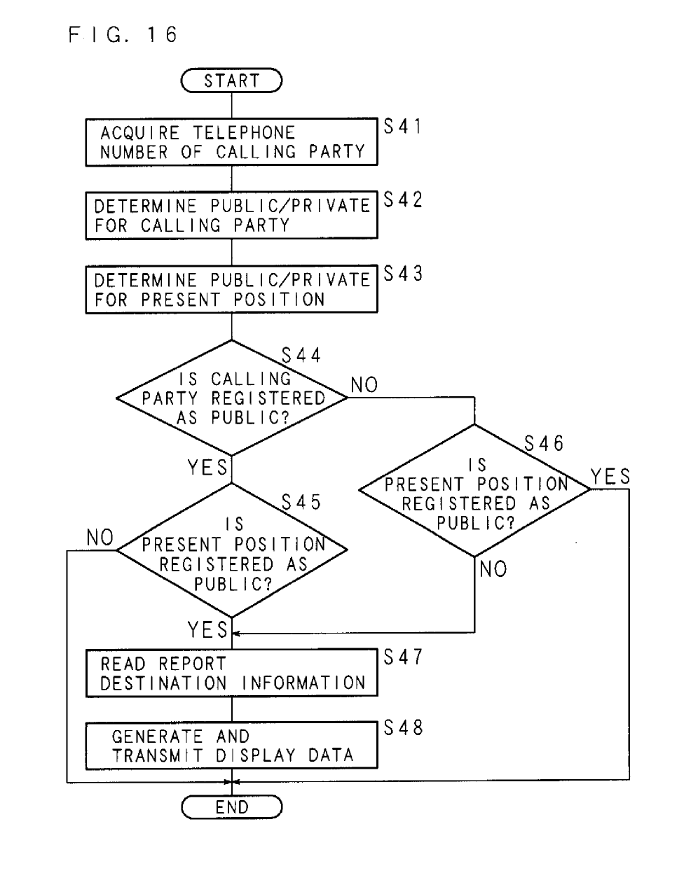

A description will be given hereinbelow to processing of reporting the incoming call to the portable telephone 1 to the computer 4 in the communication system 100 of the fourth embodiment on the basis of an operation chart. FIG. 16 is the operation chart illustrating the procedure for the report processing of the incoming call by the portable telephone 1. It is to be noted that the following processing is executed by the control part 10 in accordance with the control programs stored in the ROM 11 or the memory part 13 of the portable telephone 1.

When receiving the packet reporting the incoming call from the call control server 3 or from the base station provided in the public telephone network N, the control part 10 of the portable telephone 1 analyzes the received packet, and acquires the telephone number of the portable telephone 1 on the calling side (at S41). The control part 10 determines the distinction between the public use and the private use for the acquired telephone number, i.e., the distinction between the public use and the private use for the calling party on the basis of the registered content of the calling party table 13a (at S42). Further, the control part 10 determines the distinction between the public use and the private use for the present nearest wireless AP 2 indicated by the wireless AP information stored in the memory part 13, i.e., the distinction between the public use and the private use for the present position of the portable telephone 1 on the basis of the registered content of the position table 13b (at S43).

The control part 10 determines whether or not the “public” is registered for the calling party in the calling party table 13a in the determination processing in the operation at S42 (at S44) and, when the “public” is registered (at S44: YES), the control part 10 determines whether or not the “public” is registered for the present position in the position table 13b in the determination processing in the operation at S43 (at S45).

When the “public” is registered for the present position (at S45: YES), i.e., when the “public” is registered for both of the calling party and the present position, the control part 10 reads the report destination information in correspondence to the telephone number of the portable telephone 1 on the calling side acquired in the operation at S41 from the calling party table 13a (at S47). The control part 10 generates the display data for reporting the presence of the incoming call to the portable telephone 1 thereof, transmits the generated display data to the computer 4 as the report destination indicated by the report destination information read from the calling party table 13a (at S48), and ends the processing.

When the “public” is not registered for the present position (at S45: NO), i.e., when the “public” is registered for the calling party, and the “private” is registered for the present position, the control part 10 ends the report processing of the incoming call described above.

When the “public” is not registered for the calling party in the calling party table 13a in the operation at S44 (at S44: NO), the control part 10 determines whether or not the “public” is registered for the present position in the position table 13b in the determination processing in the operation at S43 (at S46). When the “public” is registered for the present position (at S46: YES), i.e., when the “private” is registered for the calling party and the “public” is registered for the present position, the control part 10 ends the report processing of the incoming call described above.

When the “public” is not registered for the present position in the operation at S46 (at S46: NO), i.e., when the “private” is registered for both of the calling party and the present position, the control part 10 reads the report destination information in correspondence to the telephone number of the portable telephone 1 on the calling side acquired in the operation at S41 from the calling party table 13a (at S47). The control part 10 generates the display data for reporting the presence of the incoming call to the portable telephone 1 thereof, transmits the generated display data to the computer 4 as the report destination indicated by the report destination information read from the calling party table 13a (at S48), and ends the processing.

As has been described above, in the computer 4 to which the display data is transmitted from the portable telephone 1 at which the incoming call has arrived, the control part 40 reads the report screen display processing program 43a stored in the HDD 43 into the RAM 42, and sequentially executes the program 43a to cause the display part 45 to display the report screens as illustrated in FIGS. 6A and 6B. With this operation, the presence of the incoming call to the portable telephone 1 may be reported to the user of the computer 4.

With the above-described processing, in the fourth embodiment, when the incoming call arrives at the portable telephone 1, the presence of the incoming call is reported to the computer 4 as the report destination preset for the calling party. Accordingly, the owner of the portable telephone 1 may recognize the presence or absence of the incoming call using the computer 4 desired in accordance with the calling party. In addition, when the owner of the portable telephone 1 may not answer the incoming call, the presence or absence of the incoming call may be reported to the user of the desired computer 4. Further, by setting, e.g., the computer which is not used by other users, or the computer in which private information may be opened as the report destination to which the incoming call from the telephone for private use is reported, the private information is not carelessly opened to others. Consequently, privacy may be adequately protected.

Similarly to the portable telephone 1 of the first embodiment, the portable telephone 1 of the fourth embodiment described above is structured to report the presence of the incoming call to the computer 4 every time the incoming call via the network L1 or the public telephone network N arrives. However, similarly to the portable telephone 1 of the second embodiment, the portable telephone 1 of the fourth embodiment may also be structured to suspend the operation for a given period of time (for example, about 10 seconds) as the waiting time period between the sensing of the incoming call and the transmission of the display data for reporting the incoming call to the computer 4. In this case, when the incoming call is answered by the owner of the portable telephone 1 or the owner of the different portable telephone 1 belonging to the same group within the given period of time since the sensing of the incoming call, the report processing to the computer 4 is not performed. Consequently, the occurrence of unneeded report processing may be suppressed.

In the fourth embodiment described above, the description has been given by taking, as an example, the portable telephone 1 structured to determine whether or not the presence of the incoming call is reported to the computer 4 in accordance with the distinction between the public use and the private use preset for the calling party and the distinction between the public use and the private use preset for the present position of the portable telephone 1 when the incoming call arrives. The fourth embodiment may be applied to the third embodiment. Specifically, the portable telephone 1 may also be structured to determine whether or not the presence of the incoming call is reported to the computer 4 in accordance with the state of the portable telephone 1, and report the presence of the incoming call to the computer 4 as the report destination in accordance with the calling party when it is determined that the presence of the incoming call is reported.

### Fifth Embodiment

A detailed description will be given hereinbelow to a telephone apparatus on the basis of the drawings illustrating a portable telephone according to a fifth embodiment. It is to be noted that, since the communication system 100 of the fifth embodiment may be implemented by the individual apparatuses constituting the communication system 100 of the first embodiment, the description will be given on the assumption that the communication system 100 is comprised of the portable telephone 1, the wireless AP 2, the call control server 3, and the computer 4 each of the first embodiment.

The portable telephone 1 of the first embodiment described above is structured to determine whether or not the presence of the incoming call is reported to the computer 4 by performing the given determination processing when the incoming call arrives, and generate the display data for causing the report screens as illustrated in FIGS. 6A and 6B to be displayed and transmit the generated display data to the given computer 4 when it is determined that the presence of the incoming call is reported to the computer 4.

The portable telephone 1 of the fifth embodiment is structured to report the presence of the incoming call to the computer 4 in correspondence to the present position of the portable telephone 1 at the point when the incoming call arrives. Accordingly, the owner of the portable telephone 1 may recognize the presence or absence of the incoming call using a different computer 4 in accordance with the present position thereof.

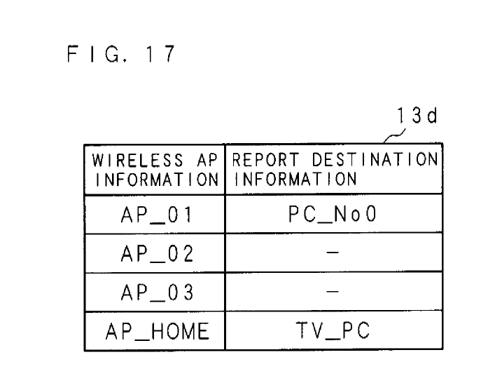

The portable telephone 1 of the fifth embodiment stores a report destination table 13d as illustrated in FIG. 17 in the memory part 13. As illustrated in FIG. 17, in the report destination table 13d, the report destination information is registered in association with the wireless AP information for identifying the wireless APs 2, 2 . . . connected to the network L1. It is to be noted that a plurality of computers 4 may be registered in the section of the report destination information, and not only the computer 4 connected via the network L1 but also the computer connected via the Internet I may also be registered as the report destination. Every time the report destination in correspondence to each of the installation locations of the wireless APs 2, 2, . . . is added or modified via the operation part 16 by the owner of the portable telephone 1, the additional report destination is added to the registered content of the report destination table 13d, or the registered content of the report destination table 13d is modified by the control part 10.

In the communication system 100 of the fifth embodiment, similarly to the first embodiment, the control part 10 of the portable telephone 1 performs communication with the nearest wireless AP 2 via the first communication part 14 at given time intervals, and sequentially updates and stores the wireless AP information identifying the nearest wireless AP 2 in the memory part 13 every time the nearest wireless AP 2 is detected.

When sensing the incoming call from the different portable telephone 1 via the network L1 or the public telephone network N, the control part 10 identifies the calling party. In addition, on the basis of the wireless AP information stored in the memory part 13 at the point of the sensing, the control part 10 reads the report destination information in correspondence to the installation location of the wireless AP 2 identified by the wireless AP information, i.e., the present position of the owner of the portable telephone 1 from the report destination table 13d. Subsequently, the control part 10 generates the display data for causing the report screens as illustrated in FIGS. 6A and 6B to be displayed, and transmits the generated display data to the computer 4 as the report destination indicated by the read report destination information via the first communication part 14. With this operation, the computer 4 may cause the display part 45 to display the report screens as illustrated in FIGS. 6A and 6B on the basis of the display data received from the portable telephone 1.

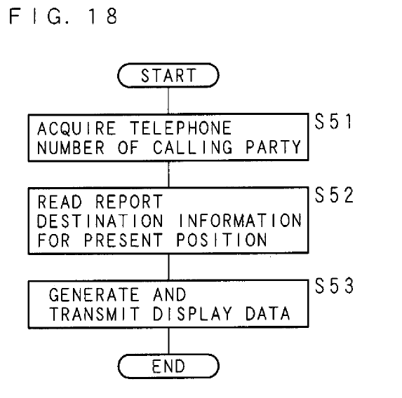

A description will be given hereinbelow to processing of reporting the incoming call to the portable telephone 1 to the computer 4 in the communication system 100 of the fifth embodiment on the basis of an operation chart. FIG. 18 is the operation chart illustrating the procedure for the report processing of the incoming call by the portable telephone 1. It is to be noted that the following processing is executed by the control part 10 in accordance with the control programs stored in the ROM 11 or the memory part 13 of the portable telephone 1.

When receiving the packet reporting the incoming call from the call control server 3 or from the base station provided in the public telephone network N, the control part 10 of the portable telephone 1 analyzes the received packet, and acquires the telephone number of the portable telephone 1 on the calling side (at S51). The control part 10 reads the report destination information in correspondence to the present nearest wireless AP 2 indicated by the wireless AP information stored in the memory part 13, i.e., the report destination information in correspondence to the present position of the portable telephone 1 from the report destination table 13d (at S52).

The control part 10 generates the display data for reporting the presence of the incoming call to the portable telephone 1 thereof, transmits the generated display data to the computer 4 as the report destination indicated by the report destination information read from the report destination table 13d (at S53), and ends the processing.

As has been described above, in the computer 4 to which the display data is transmitted from the portable telephone 1 at which the incoming call has arrived, the control part 40 reads the report screen display processing program 43a stored in the HDD 43 into the RAM 42, and sequentially executes the program 43a to cause the display part 45 to display the report screens as illustrated in FIGS. 6A and 6B. With this operation, the presence of the incoming call to the portable telephone 1 may be reported to the user of the computer 4.

With the above-described processing, in the fifth embodiment, when the incoming call to the portable telephone 1 arrives, the presence of the incoming call is reported to the computer 4 as the report destination preset for the present position of the owner of the portable telephone 1. Accordingly, the owner of the portable telephone 1 may recognize the presence or absence of the incoming call using the computer 4 desired in accordance with the present position. In addition, when the owner of the portable telephone 1 may not answer the incoming call, the presence or absence of the incoming call may be reported to the user of the desired computer 4. Further, by setting, e.g., the computer which is not used by other users, or the computer in which private information may be opened as the report destination to which the incoming call from the telephone for private use is reported, the private information is not carelessly opened to others. Consequently, privacy may be adequately protected.

The structure of the portable telephone 1 of the fifth embodiment may also be applied to the portable telephone 1 in which the structure of the portable telephone 1 of the first embodiment is combined with the structure of the portable telephone 1 of the third embodiment. Specifically, when the portable telephone 1 of the first embodiment is combined with the portable telephone 1 of the fifth embodiment, the portable telephone 1 determines whether or not the presence of the incoming call is reported to the computer 4 on the basis of the distinction between the public use and the private use for the calling party and the distinction between the public use and the private use for the present position of the portable telephone 1 and, when it is determined that the presence of the incoming call is reported, identifies the computer 4 as the report destination in correspondence to the present position of the portable telephone 1 at the point of the determination. Subsequently, the portable telephone 1 reports the presence of the incoming call to the identified computer 4 as the report destination.

On the other hand, when the portable telephone 1 of the third embodiment is combined with the portable telephone 1 of the fifth embodiment, the portable telephone 1 determines whether or not the presence of the incoming call is reported to the computer 4 in accordance with the state of the portable telephone 1 and, when it is determined that the presence of the incoming call is reported, identifies the computer 4 as the report destination in correspondence to the present position of the portable telephone 1 at the point of the determination. Then, the portable telephone 1 reports the presence of the incoming call to the identified computer 4 as the report destination.

### Sixth Embodiment

A detailed description will be given hereinbelow to a telephone apparatus and a communication system on the basis of the drawings illustrating a portable telephone and a communication system according to a sixth embodiment. It is to be noted that, since the communication system 100 of the sixth embodiment may be implemented by the individual apparatuses constituting the communication system 100 of the first embodiment, the description will be given on the assumption that the communication system 100 is comprised of the portable telephone 1, the wireless AP 2, the call control server 3, and the computer 4 each of the first embodiment.

In the communication system 100 of each of the first to fifth embodiments, the portable telephone 1 is structured to determine whether or not the presence of the incoming call is reported to the computer 4 by performing the given determination processing when the incoming call arrives, and generate the display data for causing the report screens as illustrated in FIGS. 6A and 6B to be displayed and transmit the generated display data to the given computer 4 when it is determined that the presence of the incoming call is reported.

In the communication system of the sixth embodiment, the portable telephone 1 determines whether or not the presence of the incoming call is reported to the computer 4 by performing given determination processing when the incoming call arrives, and generates the display data for causing the report screens as illustrated in FIGS. 6A and 6B to be displayed and sends an instruction to transmit the generated display data to the given computer 4 to the call control server 3 when it is determined that the presence of the incoming call is reported. Subsequently, the call control server 3 transmits the display data to the given computer 4 in accordance with the instruction acquired from the portable telephone 1. With the structure mentioned above, since the report processing to the computer 4 may be performed by the call control server 3, the burden of the processing in the portable telephone 1 may be reduced.

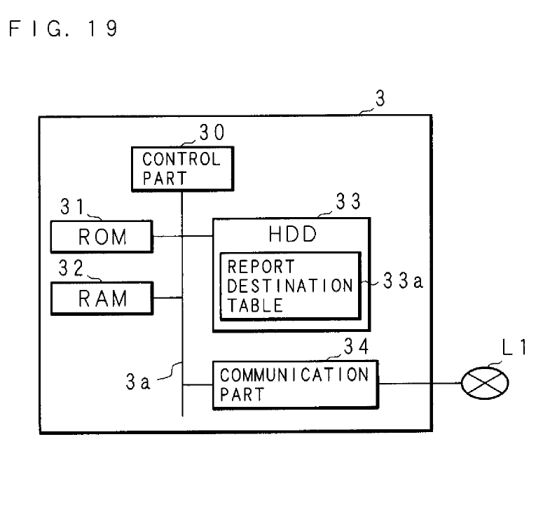

FIG. 19 is a schematic view illustrating an example of the structure of the call control server 3. The call control server 3 has a control part 30, a ROM 31, a RAM 32, a HDD 33, and a communication part 34 for the connection to the network L1, and the individual hardware parts are connected to each other via a bus 3a.

The control part 30 is comprised of the CPU or the MPU, appropriately reads the control programs pre-stored in the ROM 31 or the HDD 33 into the RAM 32 and executes the control programs, and, at the same time, controls the operations of the individual hardware parts mentioned above. In the ROM 31, various control programs required in order to cause the call control server 3 to operate as a control apparatus of the embodiment are pre-stored. The RAM 32 is comprised of the SRAM or the flash memory, and temporarily stores various data generated during the execution of the control programs by the control part 30.

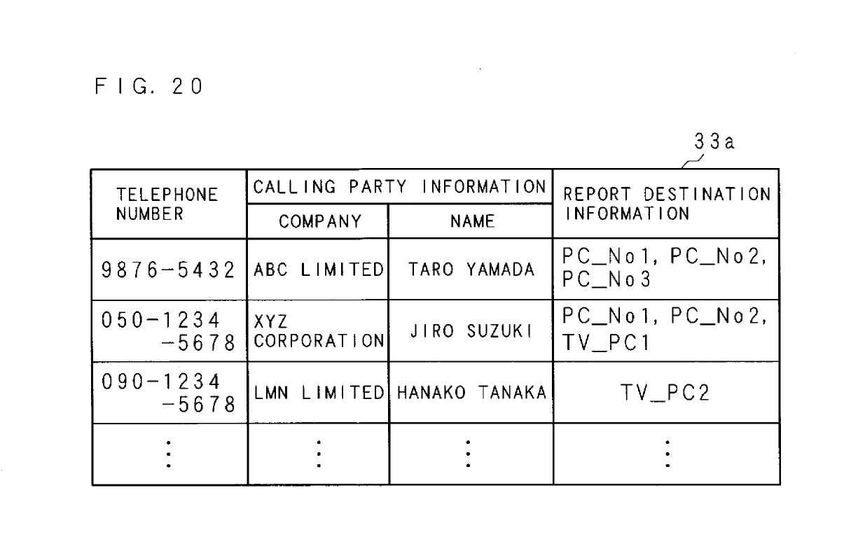

The HDD 33 is a large-capacity storage apparatus. In the HDD 33, there are pre-stored various control programs required in order to cause the call control server 3 to operate as the control apparatus of the embodiment and a report destination table 33a as illustrated in FIG. 20. In the report destination table 33a, as illustrated in FIG. 20, the telephone number of the portable telephone 1 owned by the calling party, the calling party information including the company name and the name of the calling party, and the report destination information are registered in association with each other for each pre-registered calling party.

In the section of the report destination information, a plurality of computers 4 may also be registered, and not only the computer 4 connected via the network L1 but also the computer 4 connected via the Internet I may be registered as the communication destination. Every time the information related to each calling party is added or modified by a manager capable of operating the call control server 3 via an operation part (not shown), or the information related to each calling party is added or modified by the owner of the portable telephone 1 via the portable telephone 1, the additional information is added to the registered content of the report destination table 33a, or the registered content of the report destination table 33a is modified by the control part 30.

In the communication system 100 of the sixth embodiment, similarly to the first embodiment, the control part 10 of the portable telephone 1 performs communication with the nearest wireless AP 2 via the first communication part 14 at given time intervals, and sequentially updates and stores the wireless AP information identifying the nearest wireless AP 2 in the memory part 13 every time the nearest wireless AP 2 is detected.

When sensing the incoming call from the different portable telephone 1 via the network L1 or the public telephone network N, the control part 10 identifies the calling party. The control part 10 determines the distinction between the public use and the private use for the telephone number of the portable telephone 1 on the calling side on the basis of the registered content of the calling party table 13a and, at the same time, determines the distinction between the public use and the private use for the present nearest wireless AP 2 identified by the wireless AP information stored in the memory part 13 on the basis of the registered content of the position table 13b. When determining that the presence of the incoming call is reported to the computer 4 on the basis of the determination results, the control part 10 generates the display data for causing the report screens as illustrated in FIGS. 6A and 6B to be displayed.

The control part 10 sends the instruction to transmit the generated display data to the computer 4 as the report destination together with the telephone number of the portable telephone 1 of the identified calling party and the calling party information to the call control server 3 via the first communication part 14. When acquiring the instruction to transmit the display data to the computer 4 from the portable telephone 1, the control part 30 of the call control server 3 reads the report destination information in correspondence to the acquired telephone number of the portable telephone 1 of the calling party and the acquired calling party information from the report destination table 33a. The control part 30 transmits the display data acquired from the portable telephone 1 to the computer 4 as the report destination indicated by the report destination information read from the report destination table 33a. With this operation, the computer 4 may cause the display part 45 to display the report screens as illustrated in FIGS. 6A and 6B on the basis of the display data received from the call control server 3.

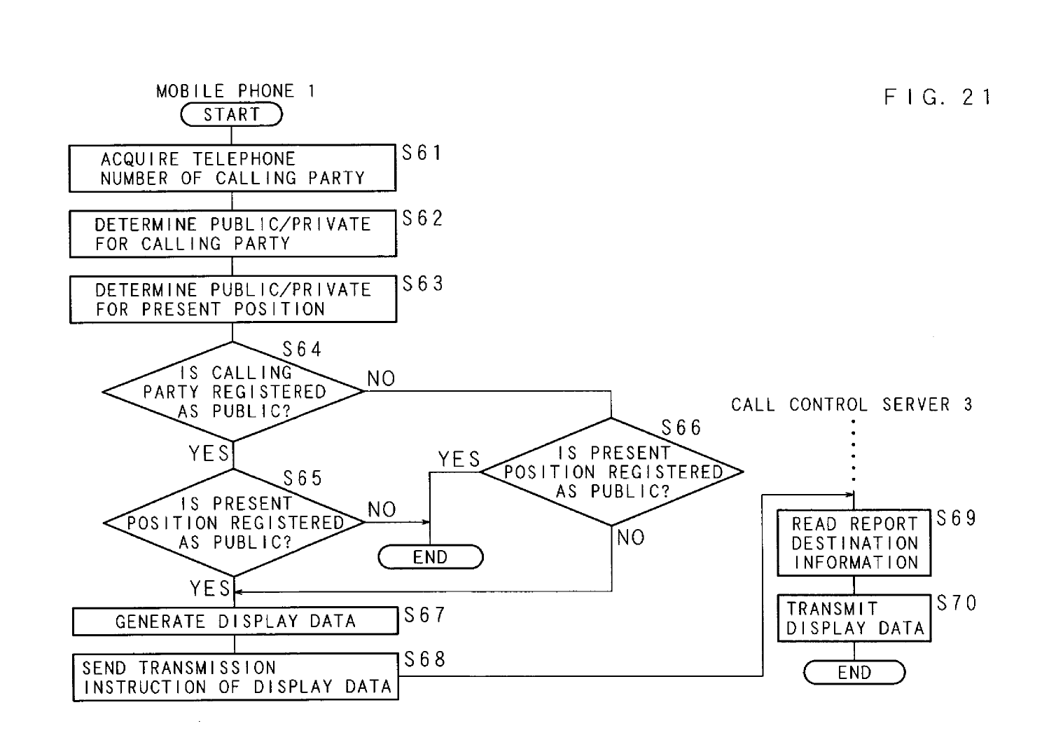

A description will be given hereinbelow to processing of reporting the incoming call to the portable telephone 1 to the computer 4 in the communication system 100 of the sixth embodiment on the basis of an operation chart. FIG. 21 is the operation chart illustrating the procedure for the report processing of the incoming call by the portable telephone 1. It is to be noted that the following processing is executed by the control part 10 in accordance with the control programs stored in the ROM 11 or the memory part 13 of the portable telephone 1, and is executed also by the control part 30 in accordance with the control programs stored in the ROM 31 or the HDD 33 of the call control server 3.

When receiving the packet reporting the incoming call from the call control server 3, or from the base station provided in the public telephone network N, the control part 10 of the portable telephone 1 analyzes the received packet and acquires the telephone number of the portable telephone 1 on the calling side (at S61). The control part 10 determines the distinction between the public use and the private use for the acquired telephone number, i.e., the distinction between the public use and the private use for the calling party on the basis of the registered content of the calling party table 13a (at S62).

The control part 10 determines the distinction between the public use and the private use for the present nearest wireless AP 2 indicated by the wireless AP information stored in the memory part 13, i.e., the distinction between the public use and the private use for the present position of the portable telephone 1 on the basis of the registered content of the position table 13b (at S63). In the determination processing in the operation at S62, the control part 10 determines whether or not the “public” is registered for the calling party in the calling party table 13a (at S64) and, when the “public” is registered (at S64: YES), determines whether or not the “public” is registered for the present position in the position table 13b in the determination processing in the operation at S63 (at S65).

When the “public” is registered for the present position (at S65: YES), i.e., when the “public” is registered for both of the calling party and the present position, the control part 10 generates the display data for reporting the presence of the incoming call to the portable telephone 1 thereof (at S67), and sends the instruction to transmit the generated display data to the computer 4 together with the telephone number of the portable telephone 1 of the calling party and the calling party information to the call control server 3 via the first communication part 14 (at S68).

When the “public” is not registered for the present position (at S65: NO), i.e., when the “public” is registered for the calling party, and the “private” is registered for the present position, the control part 10 ends the report processing of the incoming call described above. When the “public” is not registered for the calling party in the calling party table 13a in the operation at S64 (at S64: NO), the control part 10 determines whether or not the “public” is registered for the present position in the position table 13b in the determination processing in the operation at S63 (at S66).

When the “public” is registered for the present position (at S66: YES), i.e., when the “private” is registered for the calling party, and the “public” is registered for the present position, the control part 10 ends the report processing of the incoming call described above.

When the “public” is not registered for the present position in the operation at S66 (at S66: NO), i.e., when the “private” is registered for both of the calling party and the present position, the control part 10 generates the display data for reporting the presence of the incoming call to the portable telephone 1 thereof (at S67), and sends the instruction to transmit the generated display data to the computer 4 together with the telephone number of the portable telephone 1 of the calling party and the calling party information to the call control server 3 via the first communication part 14 (at S68).

The control part 30 of the call control server 3 having acquired the display data from the portable telephone 1 reads, from the report destination table 33a, the report destination information in correspondence to the telephone number of the portable telephone 1 of the calling party and the calling party information acquired together with the display data from the portable telephone 1 (at S69). The control part 30 transmits the display data acquired from the portable telephone 1 to the computer 4 as the report destination indicated by the report destination information read from the report destination table 33a (at S70), and ends the report processing of the incoming call described above.

As has been described above, in the computer 4 to which the display data is transmitted from the call control server 3, the control part 40 reads the report screen display processing program 43a stored in the HDD 43 into the RAM 42, and sequentially executes the program 43a to cause the display part 45 to display the report screens as illustrated in FIGS. 6A and 6B. With this operation, the presence of the incoming call to the portable telephone 1 may be reported to the user of the computer 4.

With the above-described processing, in the sixth embodiment, the call control server 3 performs the processing of transmitting the display data for reporting the presence of the incoming call to the computer 4, whereby the burden of the processing in the portable telephone 1 may be reduced.

Similarly to the portable telephone 1 of the first embodiment, the portable telephone 1 of the sixth embodiment described above is structured to report the presence of the incoming call to the computer 4 every time the incoming call via the network L1 or the public telephone network N arrives. However, similarly to the portable telephone 1 of the second embodiment, the portable telephone 1 of the sixth embodiment may be structured to suspend the operation for a given period of time (for example, about 10 seconds) as a waiting time period between the sensing of the incoming call and the transmission of the display data for reporting the incoming call to the computer 4.

In this case, when the incoming call is answered by the owner of the portable telephone 1 or the owner of the different portable telephone 1 belonging to the same group within the given period of time since the sensing of the incoming call, the report processing to the computer 4 is not performed. Consequently, the occurrence of unneeded report processing may be suppressed. Specifically, processing of suspending the operation till the given period of time elapses may be appropriately added between the operations at S67 and S68 in the processing illustrated in FIG. 21.

The sixth embodiment described above has a structure in which the processing of transmitting the display data to the computer 4 by the portable telephone 1 in the communication system 100 of the first embodiment is performed by the call control server 3 instead of the portable telephone 1, and has been described as a modification of the first embodiment. Similarly, the sixth embodiment may also be applied to the second to fifth embodiments.

For example, in a case where the structure of the sixth embodiment is applied to the third embodiment, when the incoming call arrives from the different portable telephone 1, the portable telephone 1 determines whether or not the presence of the incoming call is reported to the computer 4 in accordance with the state of the portable telephone 1 of concern, and generates the display data when determining that the presence of the incoming call is reported. In addition, the portable telephone 1 transmits the instruction to transmit the generated display data to the computer 4 as the corresponding report destination to the call control server 3, and the call control server 3 executes the processing of transmitting the display data to the computer 4.

### Seventh Embodiment

A detailed description will be given hereinbelow to a telephone apparatus on the basis of the drawings illustrating a portable telephone according to a seventh embodiment. It is to be noted that, since the communication system 100 of the seventh embodiment may be implemented by the individual apparatuses constituting the communication system 100 of the first embodiment, the description will be given on the assumption that the communication system 100 is comprised of the portable telephone 1, the wireless AP 2, the call control server 3, and the computer 4 each of the first embodiment.

The seventh embodiment is a modification of the fourth embodiment, and the portable telephone 1 of the fourth embodiment is structured to report the presence of the incoming call to the computer 4 as the report destination in correspondence to the portable telephone 1 on the calling side, i.e., the calling party when the portable telephone 1 determines that the presence of the incoming call is reported to the computer 4.

In contrast to this structure, the portable telephone 1 of the seventh embodiment is structured to prioritize a plurality of report destinations registered to be notified of the presence of the incoming call, and report the presence of the incoming call to the report destinations in correspondence to the portable telephone 1 on the calling side, i.e., the calling party in descending order of priority when the portable telephone 1 determines that the presence of the incoming call is reported to the computer 4. Accordingly, the presence or absence of the incoming call may be more efficiently reported to the owner of the portable telephone 1.

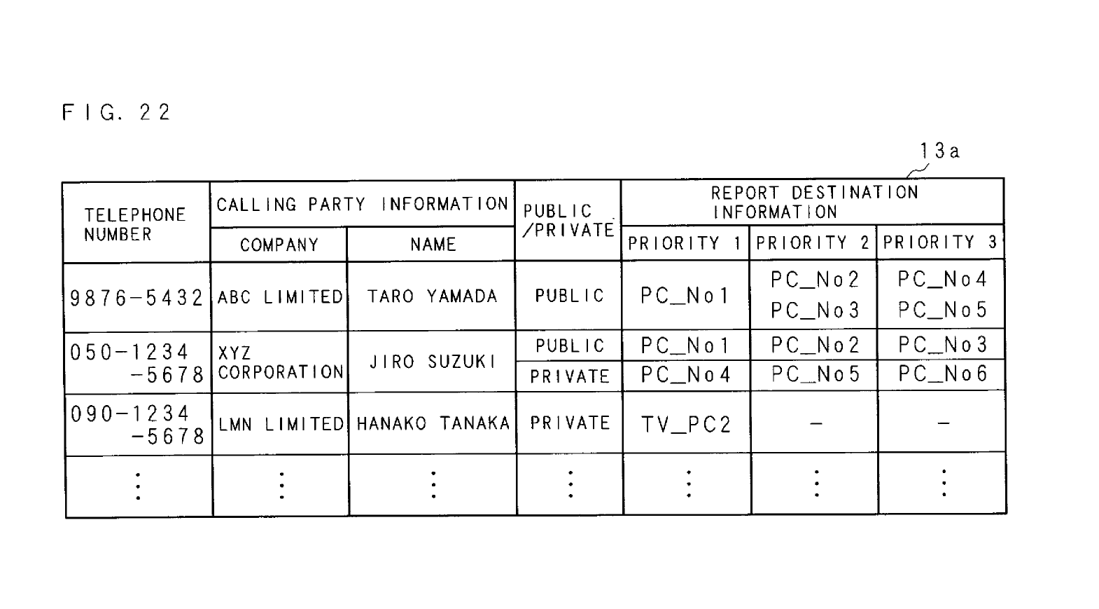

The portable telephone 1 of the seventh embodiment stores the calling party table 13a as illustrated in FIG. 22 in the memory part 13. In the calling party table 13a, as illustrated in FIG. 22, the telephone number of the portable telephone 1 owned by the calling party, the calling party information including the company name and the name of the calling party, the distinction between the public use and the private use, and the report destination information are registered in association with each other for each pre-registered calling party.

In the section of the report destination information, in correspondence to the “public” and the “private” registered in the section of the distinction between the public use and the private use for each calling party, the information on the communication destinations to which the first, second, and third priorities are assigned is registered. Every time the information related to each calling party is added or modified by the owner of the portable telephone 1 via the operation part 16, the additional information is added to the registered content of the calling party table 13a, or the registered content of the calling party table 13a is modified by the control part 10.

In the communication system 100 of the seventh embodiment, similarly to the fourth embodiment, the control part 10 of the portable telephone 1 performs communication with the nearest wireless AP 2 via the first communication part 14 at given time intervals, and sequentially updates and stores the wireless AP information identifying the nearest wireless AP 2 in the memory part 13 every time the nearest wireless AP 2 is detected.

When sensing the incoming call from the different portable telephone 1 via the network L1 or the public telephone network N, the control part 10 identifies the calling party. In addition, the control part 10 determines the distinction between the public use and the private use for the telephone number of the portable telephone 1 on the calling side on the basis of the registered content of the calling party table 13a and, at the same time, determines the distinction between the public use and the private use for the present nearest wireless AP 2 identified by the wireless AP information stored in the memory part 13 on the basis of the registered content of the position table 13b. Subsequently, when determining that the presence of the incoming call is reported to the computer 4 on the basis of the determination results, the control part 10 generates the display data for causing the report screens as illustrated in FIGS. 6A and 6B to be displayed.

Then, the control part 10 reads the report destination information having the first priority among the report destination information registered in correspondence to the telephone number of the portable telephone 1 on the calling side in the calling party table 13a, and transmits the display data to the computer 4 as the report destination indicated by the read report destination information via the first communication part 14. When transmitting the display data to the computer 4 having the first priority, the control part 10 starts measurement processing of a given period of time and, when the incoming call is answered before the given period of time elapses, ends the report processing of the incoming call described above.

When the incoming call is not answered before the given period of time elapses since the transmission of the display data to the report destination having the first priority, the control part 10 reads the report destination information having a priority next to the first priority among the report destination information registered in correspondence to the telephone number of the portable telephone 1 on the calling side in the calling party table 13a, specifically, the control part 10 reads the report destination information having the second priority, and transmits the display data to the computer 4 as the report destination indicated by the read report destination information via the first communication part 14. Subsequently, the control part 10 restarts the measurement processing of the given period of time, and ends the report processing of the incoming call described above when the incoming call is answered before the given period of time elapses.

When the incoming call is not answered before the given period of time elapses since the transmission of the display data to the report destination having the second priority, the control part 10 reads the report destination information having a priority next to the second priority among the report destination information registered in correspondence to the telephone number of the portable telephone 1 on the calling side in the calling party table 13a, specifically, the control part 10 reads the report destination information having the third priority, and transmits the display data to the computer 4 as the report destination indicated by the read report destination information via the first communication part 14. Since the calling party table 13a of the fourth embodiment described above is structured to register the report destinations having the first to third priorities, when the display data is transmitted to the report destination having the third priority, the report processing of the incoming call described above is ended.

With the above-described processing, the computers 4 set as the report destinations may receive the display data from the portable telephone 1 in the order in accordance with their respective priorities, and cause the display part 45 to display the report screens as illustrated in FIGS. 6A and 6B on the basis of the received display data. With this operation, the owner of the portable telephone 1 at which the incoming call has arrived may recognize the presence of the incoming call via any of the computers 4.

The report destination having the first priority includes, e.g., the computer of the owner of the portable telephone 1 at which the incoming call has arrived, the report destination having the second priority includes, e.g., the computer of a person belonging to the business-related group to which the owner of the portable telephone 1 at which the incoming call has arrived belongs, and the report destination having the third priority includes, e.g., the computer of a person handling incoming calls as a representative in a bigger group.

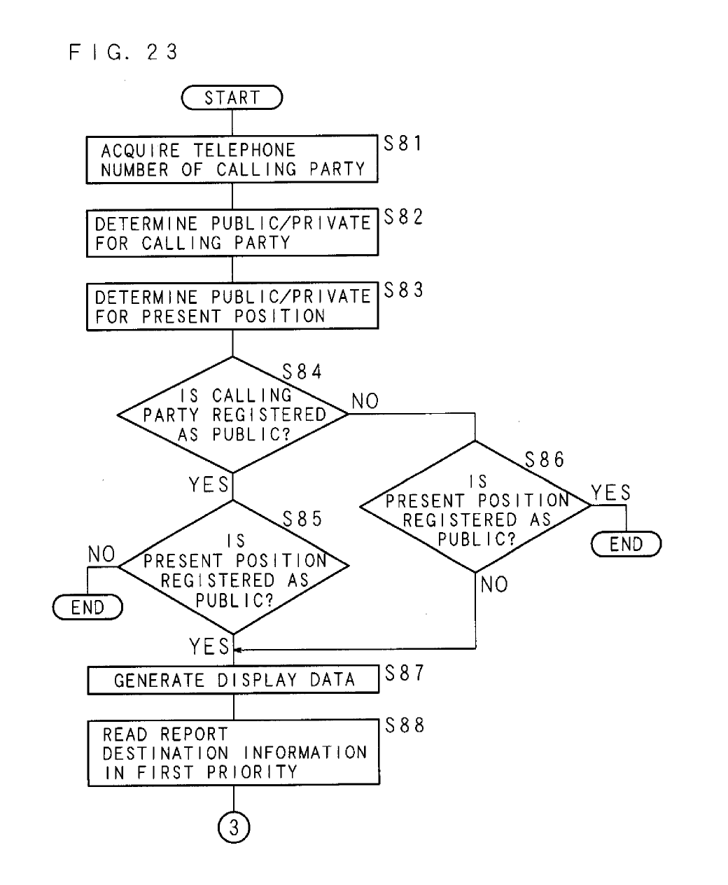

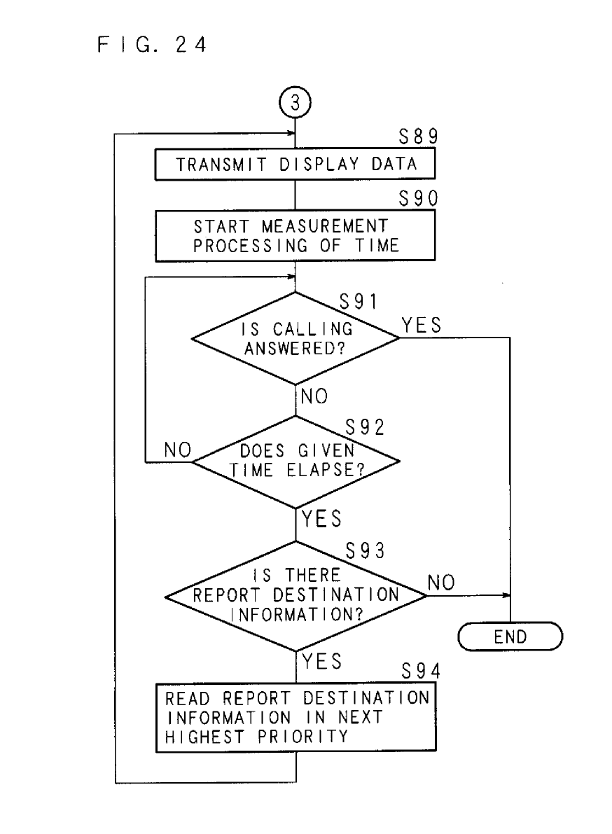

A description will be given hereinbelow to processing of reporting the incoming call to the portable telephone 1 to the computer 4 in the communication system 100 of the seventh embodiment on the basis of operation charts. FIGS. 23 and 24 are the operation charts each illustrating the procedure for the report processing of the incoming call by the portable telephone 1. It is to be noted that the following processing is executed by the control part 10 in accordance with the control programs stored in the ROM 11 or the memory part 13 of the portable telephone 1.

When receiving the packet reporting the incoming call from the call control server 3, or from the base station provided in the public telephone network N, the control part 10 of the portable telephone 1 analyzes the received packet, and acquires the telephone number of the portable telephone 1 on the calling side (at S81). The control part 10 determines the distinction between the public use and the private use for the acquired telephone number, i.e., the distinction between the public use and the private use for the calling party on the basis of the registered content of the calling party table 13a (at S82). In addition, the control part 10 determines the distinction between the public use and the private use for the present nearest wireless AP 2 indicated by the wireless AP information stored in the memory part 13, i.e., the distinction between the public use and the private use for the present position of the portable telephone 1 on the basis of the registered content of the position table 13b (at S83).

The control part 10 determines whether or not the “public” is registered for the calling party in the calling party table 13a in the determination processing in the operation at S82 (at S84) and, when the “public” is registered (at S84: YES), determines whether or not the “public” is registered for the present position in the position table 13b in the determination processing in the operation at S83 (at S85).

When the “public” is registered for the present position (at S85: YES), i.e., when the “public” is registered for both of the calling party and the present position, the control part 10 moves the processing to the operation at S87. When the “public” is not registered for the present position (at S85: NO), i.e., when the “public” is registered for the calling party, and the “private” is registered for the present position, the control part 10 ends the report processing of the incoming call described above.

When the “public” is not registered for the calling party in the calling party table 13a in the operation at S84 (at S84: NO), the control part 10 determines whether or not the “public” is registered for the present position in the position table 13b in the determination processing in the operation at S83 (at S86). When the “public” is registered for the present position (at S86: YES), i.e., when the “private” is registered for the calling party, and the “public” is registered for the present position, the control part 10 ends the report processing of the incoming call described above.

When the “public” is not registered for the present position in the operation at S86 (at S86: NO), i.e., when the “private” is registered for both of the calling party and the present position, the control part 10 moves the processing to the operation at S87. In the operation at S87, the control part 10 generates the display data for reporting the presence of the incoming call to the portable telephone 1 thereof (at S87). The control part 10 reads, from the calling party table 13a, the report destination information having the first priority among the report destination information in correspondence to the telephone number of the portable telephone 1 on the calling side acquired in the operation at S81 (at S88).

The control part 10 transmits the display data generated in the operation at S87 to the computer 4 as the report destination indicated by the report destination information having the first priority read from the calling party table 13a (at S89), and starts the measurement processing of the given period of time using the timer 10a (at S90). The control part 10 determines whether or not the incoming call is answered in accordance with whether or not the control part 10 receives the packet reporting that the incoming call is answered from the call control server 3 or whether or not the control part 10 receives the packet reporting that the incoming call is answered from the base station provided in the public telephone network N (at S91).

When determining that the incoming call is not answered (at S91: NO), the control part 10 determines whether or not the given period of time has elapsed from the result of the measurement processing by the timer 10a (at S92) and, when the given period of time has not elapsed (at S92: NO), the control part 10 returns the processing to the operation at S91. When the given period of time has elapsed (at S92: YES), i.e., when the incoming call is not answered within the given period of time, the control part 10 determines whether or not the report destination information in correspondence to the telephone number of the portable telephone 1 on the calling side acquired in the operation at S81 is still present in the calling party table 13a (at S93).

When determining that the report destination information is still present (at S93: YES), the control part 10 reads the report destination information having a priority next to the first priority among the report destination information in correspondence to the telephone number of the portable telephone 1 on the calling side from the calling party table 13a (at S94). The control part 10 returns the processing to the operation at S89, and transmits the display data generated in the operation at S87 to the computer 4 as the report destination indicated by the report destination information read from the calling party table 13a (at S89).

The control part 10 repeats the processing in the operations at S89 to S94 described above until the incoming call is answered or until the display data is transmitted to all of the report destinations in correspondence to the telephone number of the portable telephone 1 on the calling side and, when the control part 10 determines that the incoming call is answered (at S91: YES) or when the control part 10 determines that the report destination information is not present in the calling party table 13a (at S93: NO), the control part 10 ends the above-described processing.

As has been described above, in the computer 4 to which the display data is transmitted from the portable telephone 1 at which the incoming call has arrived, the control part 40 reads the report screen display processing program 43a stored in the HDD 43 into the RAM 42, and sequentially executes the program 43a to cause the display part 45 to display the report screens as illustrated in FIGS. 6A and 6B. With this operation, the presence of the incoming call to the portable telephone 1 may be reported to the user of the computer 4.

With the above-described processing, in the seventh embodiment, when the incoming call to the portable telephone 1 arrives, the presence of the incoming call is reported to the computers 4 as the report destinations preset for the calling party in accordance with their respective set priorities. Accordingly, the owner of the portable telephone 1 may recognize the presence or absence of the incoming call using the computers 4 desired in accordance with the calling party. In addition, when the owner of the portable telephone 1 may not answer the incoming call, the presence or absence of the incoming call may be reported to the users of the desired computers 4.

Similarly to the portable telephone 1 of the first embodiment, the portable telephone 1 of the seventh embodiment is structured to report the presence of the incoming call to the computer 4 every time the incoming call via the network L1 or the public telephone network N arrives. However, similarly to the portable telephone 1 of the second embodiment, the portable telephone 1 of the seventh embodiment may also be structured to suspend the operation for a given period of time (for example, about 10 seconds) as a waiting time period between the sensing of the incoming call and the transmission of the display data for reporting the incoming call to the computer 4. In this case, when the incoming call is answered by the owner of the portable telephone 1 or the owner of the different portable telephone 1 belonging to the same group within the given period of time since the sensing of the incoming call, the report processing to the computer 4 is not performed. Consequently, the occurrence of unneeded report processing may be suppressed.

In the seventh embodiment described above, the description has been given by taking, as an example, the portable telephone 1 structured to determine whether or not the presence of the incoming call is reported to the computer 4 in accordance with the distinction between the public use and the private use preset for the calling party and the distinction between the public use and the private use preset for the present position of the portable telephone 1. The seventh embodiment may also be applied to the third embodiment. Specifically, the portable telephone 1 may also be structured to determine whether or not the presence of the incoming call is reported to the computer 4 in accordance with the state of the portable telephone 1, and report the presence of the incoming call to the computers 4 as the report destinations in correspondence to the calling party in accordance with their respective set priorities when the portable telephone 1 determines that the presence of the incoming call is reported to the computer 4.

In the aspect, when sensing the incoming call from the different telephone apparatus, the telephone apparatus acquires a type of use preset for a calling party which indicates whether the sensed incoming call is from the telephone for business use or the telephone for private use on the basis of the telephone apparatus on the calling side and, at the same time, acquires a type of use preset for the present position which indicates whether the telephone apparatus of concern is presently at a business-related location or a non-business-related location. The telephone apparatus determines whether or not the presence of the incoming call from the telephone apparatus on the calling side is reported to the given communication apparatus in accordance with their respective types of use, and reports the presence of the incoming call as needed. Consequently, the presence or absence of the incoming call may be reported to the given communication apparatus in accordance with whether the owner of the telephone apparatus on the calling side is a business-related person or a non-business-related person, and whether the owner of the telephone apparatus of concern is on duty or off duty.

For example, when the type of use for the calling party and the type of use for the present position of the called party indicate the same type of use, specifically, when the incoming call from the telephone for business use arrives during working hours for the owner of the telephone apparatus such as a case where the sensed incoming call is from the telephone for business use, and the called party is at the business-related location, it is determined that the presence of the incoming call is reported to the given communication apparatus. On the other hand, when the incoming call from the telephone for private use arrives before or after working hours for the owner of the telephone apparatus such as a case where the sensed incoming call is from the telephone for private use and the called party is at the non-business-related location, it is determined that the presence of the incoming call is reported to the given communication apparatus. Accordingly, the report to the given communication apparatus may be performed only when the report of the incoming call is necessary.

This allows the owner of the telephone apparatus or the user of the given communication apparatus to reliably recognize the presence of the incoming call via the given communication apparatus and reliably answer the incoming call. In addition, for example, when the incoming call from the telephone for private use arrives during working hours for the owner of the telephone apparatus, or when the incoming call from the telephone for business use arrives before or after business hours for the owner of the telephone apparatus, the presence of the incoming call is not reported to the given communication apparatus. Consequently, the occurrence of unneeded report processing may be suppressed.

In the aspect, when sensing the incoming call from the different telephone apparatus, the telephone apparatus determines whether or not the presence of the incoming call from the telephone apparatus on the calling side is reported to the given communication apparatus on the basis of the state of the telephone apparatus of concern. Consequently, in accordance with the state of the telephone apparatus of concern, specifically, in accordance with the state of placement of the telephone apparatus of concern, the presence or absence of the incoming call may be reported to the given communication apparatus. Specifically, when there is a possibility that the telephone apparatus is unattended such as, e.g., a case where the telephone apparatus is being charged, a case where the telephone apparatus is placed on a desk or the like with a given side surface thereof as a bottom surface, or a case where the same state of the placement continues for longer than a given period of time, the telephone apparatus determines that the presence of the incoming call from the telephone apparatus on the calling side is reported to the given communication apparatus. Accordingly, even when the telephone apparatus is unattended by the owner of the telephone apparatus, the owner of the telephone apparatus or the user of the given communication apparatus may recognize the presence of the incoming call via the given communication apparatus, and reliably answer the incoming call. In addition, when the owner is likely to answer the incoming call such as, e.g., a case where the telephone apparatus is carried by the owner, the presence of the incoming call is not reported to the given communication apparatus. Consequently, the occurrence of unneeded report processing may be suppressed.

In the aspect, the presence of the incoming call from the telephone apparatus on the calling side to the telephone apparatus of concern is reported to the communication apparatus preset in correspondence to the telephone apparatus on the calling side. Consequently, the owner of the telephone apparatus may recognize the presence or absence of the incoming call via an arbitrary communication apparatus, and the presence or absence of the incoming call may be reported to the user of the arbitrary communication apparatus. This allows the owner of the telephone apparatus or the user of the arbitrary communication apparatus to reliably answer the incoming call when the incoming call arrives. In addition, by setting, e.g., the communication apparatus which is not used by other users, or the communication apparatus in which private information may be opened as the communication apparatus to which the presence of the incoming call from the telephone for private use is reported, privacy may be adequately protected.

In the aspect, in a case where the incoming call is not answered when a given period of time has elapsed since sensing of the incoming call, the presence of the incoming call from the telephone apparatus on the calling side to the telephone apparatus of concern is reported to the given communication apparatus. Consequently, since the report to the given communication apparatus is not performed when the owner of the telephone apparatus answers the incoming call within the given period of time, the occurrence of unneeded report processing may be suppressed.

In the aspect, when it is determined that the presence of the incoming call is reported to the given communication apparatus, an instruction to report the presence of the incoming call from the telephone apparatus on the calling side to the telephone apparatus of concern to the given communication apparatus is sent to another given communication apparatus (control apparatus). The control apparatus reports the presence of the incoming call from the telephone apparatus on the calling side to the telephone apparatus having sent the instruction to the given communication apparatus in accordance with the acquired instruction. When the presence of the incoming call from the telephone apparatus on the calling side to the telephone apparatus having sent the instruction is reported to the given communication apparatus, the given communication apparatus displays a display screen indicative of the content of the report. Consequently, the owner of the telephone apparatus or the user of the given communication apparatus may reliably recognize the presence or absence of the incoming call on the basis of the information displayed on the display screen. In addition, the control apparatus performs the processing of reporting the presence of the incoming call to the given communication apparatus, whereby a burden of the processing in the telephone apparatus may be reduced.

In the aspect, when the incoming call from the different telephone apparatus is sensed, the communication apparatus in correspondence to the present position of the telephone apparatus of concern is identified, and the presence of the incoming call from the telephone apparatus on the calling side to the telephone apparatus of concern is reported to the identified communication apparatus. Consequently, the presence or absence of the incoming call may be reported to the arbitrary communication apparatus in accordance with the present position of the telephone apparatus at which the incoming call has arrived. Accordingly, by registering the communication apparatus to which the presence of the incoming call is to be reported in correspondence to each position, the incoming call may be excellently answered when the presence of the incoming call is reported. Further, by setting, e.g., the communication apparatus which is not used by other users or the communication apparatus in which private information may be opened as the communication apparatus to which the presence of the incoming call is reported, privacy may be adequately protected.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A telephone apparatus for communicating with a different telephone apparatus via a network, comprising:
a telephone apparatus table in which first use type information indicating a type of use preset for the telephone apparatus is registered in association with telephone apparatus information identifying the telephone apparatus;
a position table in which second use type information indicating the type of use preset for a position of the telephone apparatus is registered in association with the position;
a position detection part detecting a present position of the telephone apparatus of concern;
a sensing part sensing an incoming call from the different telephone apparatus via the network;
a detection part detecting a telephone apparatus on a calling side when the sensing part senses the incoming call;
a first acquisition part acquiring the first use type information on the telephone apparatus on the calling side detected by the detection part from the telephone apparatus table;
a second acquisition part acquiring the second use type information on the present position detected by the position detection part from the position table when the sensing part senses the incoming call;
a determination part determining whether or not presence of the incoming call from the telephone apparatus on the calling side is reported to a given communication apparatus on a basis of the first use type information acquired by the first acquisition part and the second use type information acquired by the second acquisition part; and
a report part reporting the presence of the incoming call from the telephone apparatus on the calling side to the telephone apparatus of concern to the given communication apparatus when the determination part determines that the presence of the incoming call is reported to the given communication apparatus.

2. The telephone apparatus according to claim 1, wherein, when it is determined that the first use type information and the second use type information indicate an identical use type, or when it is determined that the first use type information includes or is included by the second use type information, the determination part is structured to determine that the presence of the incoming call from the telephone apparatus on the calling side is reported to the given communication apparatus.

3. The telephone apparatus according to claim 1, further comprising:
an apparatus table in which the telephone apparatus information identifying the telephone apparatus and communication apparatus information identifying a communication apparatus are registered in association with each other; and
a part identifying the communication apparatus in correspondence to the telephone apparatus on the calling side on the basis of the apparatus table when the determination part determines that the presence of the incoming call is reported to the given communication apparatus, wherein
the report part is structured to report the presence of the incoming call from the telephone apparatus on the calling side to the telephone apparatus of concern to the identified communication apparatus.

4. The telephone apparatus according to claim 1, further comprising:
a measurement part measuring a given period of time since sensing of the incoming call by the sensing part; and
a part determining whether or not the incoming call sensed by the sensing part is answered, wherein
the report part is structured to report the presence of the incoming call from the telephone apparatus on the calling side to the telephone apparatus of concern to the given communication apparatus when the incoming call is not answered after the measurement part measures the given period of time.

5. The telephone apparatus according to claim 1, further comprising:
a part sending an instruction to report the presence of the incoming call from the telephone apparatus on the calling side to the telephone apparatus of concern to the given communication apparatus to another given communication apparatus when the determination part determines that the presence of the incoming call is reported to the given communication apparatus.

6. A telephone apparatus for communicating with a different telephone apparatus via a network, comprising:
a sensing part sensing an incoming call from the different telephone apparatus via the network;
a detection part detecting a telephone apparatus on a calling side when the sensing part senses the incoming call;
a state detection part detecting a state of the telephone apparatus of concern when the sensing part senses the incoming call;
a determination part determining whether or not presence of the incoming call from the telephone apparatus on the calling side detected by the detection part is reported to a given communication apparatus on a basis of the state detected by the state detection part; and
a report part reporting the presence of the incoming call from the telephone apparatus on the calling side to the telephone apparatus of concern to the given communication apparatus when the determination part determines that the presence of the incoming call is reported to the given communication apparatus.

7. The telephone apparatus according to claim 6, wherein the state detection part is structured to detect a state of placement of the telephone apparatus of concern.

8. The telephone apparatus according to claim 6, further comprising:
an apparatus table in which the telephone apparatus information identifying the telephone apparatus and communication apparatus information identifying a communication apparatus are registered in association with each other; and
a part identifying the communication apparatus in correspondence to the telephone apparatus on the calling side on the basis of the apparatus table when the determination part determines that the presence of the incoming call is reported to the given communication apparatus, wherein
the report part is structured to report the presence of the incoming call from the telephone apparatus on the calling side to the telephone apparatus of concern to the identified communication apparatus.

9. The telephone apparatus according to claim 6, further comprising:
a measurement part measuring a given period of time since sensing of the incoming call by the sensing part; and
a part determining whether or not the incoming call sensed by the sensing part is answered, wherein
the report part is structured to report the presence of the incoming call from the telephone apparatus on the calling side to the telephone apparatus of concern to the given communication apparatus when the incoming call is not answered after the measurement part measures the given period of time.

10. The telephone apparatus according to claim 6, further comprising:
a part sending an instruction to report the presence of the incoming call from the telephone apparatus on the calling side to the telephone apparatus of concern to the given communication apparatus to another given communication apparatus when the determination part determines that the presence of the incoming call is reported to the given communication apparatus.

11. A telephone apparatus for communicating with a different telephone apparatus via a network, comprising:
a sensing part sensing an incoming call from the different telephone apparatus via the network;
a detection part detecting a telephone apparatus on a calling side when the sensing part senses the incoming call;
a table in which a position and communication apparatus information identifying a communication apparatus preset for each position are registered in association with each other;
a position detection part detecting a present position of the telephone apparatus of concern;
a part identifying the communication apparatus in correspondence to the present position detected by the position detection part on a basis of the table when the sensing part senses the incoming call; and
a report part reporting presence of the incoming call from the telephone apparatus on the calling side detected by the detection part to the telephone apparatus of concern to the identified communication apparatus.

12. A communication system comprising:
a plurality of telephone apparatuses performing communication with each other via a network; and
a control apparatus controlling the communication between the telephone apparatuses, wherein
one of the telephone apparatuses includes:
a telephone apparatus table in which first use type information indicating a type of use preset for the telephone apparatus is registered in association with telephone apparatus information identifying the telephone apparatus;
a position table in which second use type information indicating the type of use preset for a position of the telephone apparatus is registered in association with the position;
a position detection part detecting a present position of the telephone apparatus of concern;
a sensing part sensing an incoming call from a different telephone apparatus via the network;
a detection part detecting a telephone apparatus on a calling side when the sensing part senses the incoming call;
a first acquisition part acquiring the first use type information on the telephone apparatus on the calling side detected by the detection part from the telephone apparatus table;
a second acquisition part acquiring the second use type information on the present position detected by the position detection part from the position table when the sensing part senses the incoming call;
a determination part determining whether or not presence of the incoming call from the telephone apparatus on the calling side to a given communication apparatus on a basis of the first use type information acquired by the first acquisition part and the second use type information acquired by the second acquisition part; and
a part sending an instruction to report the presence of the incoming call from the telephone apparatus on the calling side to the telephone apparatus of concern to the given communication apparatus to the control apparatus to the control apparatus when the determination part determines that the presence of the incoming call is reported to the given communication apparatus, and
the control apparatus includes a part reporting the presence of the incoming call from the telephone apparatus on the calling side to the telephone apparatus having sent the instruction to the given communication apparatus in accordance with the instruction sent from the telephone apparatus.

13. The communication system according to claim 12, wherein
the given communication apparatus has a part outputting the presence of the incoming call from the telephone apparatus on the calling side to the telephone apparatus having sent the instruction when the presence of the incoming call is reported to the given communication apparatus from the control apparatus.

14. A communication system comprising:
a plurality of telephone apparatuses performing communication with each other via a network; and
a control apparatus controlling the communication between the telephone apparatuses, wherein
one of the telephone apparatuses has:
a sensing part sensing an incoming call from a different telephone apparatus via the network;
a detection part detecting a telephone apparatus on a calling side when the sensing part senses the incoming call;
a state detection part detecting a state of the telephone apparatus of concern when the sensing part senses the incoming call;
a determination part determining whether or not presence of the incoming call from the telephone apparatus on the calling side detected by the detection part to a given communication apparatus on a basis of the state detected by the state detection part; and
a part sending an instruction to report the presence of the incoming call from the telephone apparatus on the calling side to the telephone apparatus of concern to the given communication apparatus when the determination part determines that the presence of the incoming call is reported to the given communication apparatus, and
the control apparatus has a part reporting the presence of the incoming call from the telephone apparatus on the calling side to the telephone apparatus having sent the instruction to the given communication apparatus in accordance with the instruction sent from the telephone apparatus.

15. The communication system according to claim 14, wherein
the given communication apparatus has a part outputting the presence of the incoming call from the telephone apparatus on the calling side to the telephone apparatus having sent the instruction when the presence of the incoming call is reported to the given communication apparatus from the control apparatus.

16. A computer-readable recording medium which stores a computer-executable computer program for causing a computer to control communication between telephone apparatuses performing the communication with each other via a network, the computer program comprising instructions for causing the computer to execute:
sensing a call originated from one of the telephone apparatuses via the network;
detecting a telephone apparatus on a calling side and a telephone apparatus on a called side when the call is sensed;
acquiring first use type information indicating a type of use preset for the detected telephone apparatus on the calling side;
acquiring a present position of the detected telephone apparatus on the called side;
acquiring second use type information indicating the type of use preset for the present position of the telephone apparatus on the called side;
determining whether or not presence of an incoming call from the telephone apparatus on the calling side to the telephone apparatus on the called side is reported to a given communication apparatus on a basis of the acquired first use type information and second use type information; and
sending an instruction to output the presence of the incoming call from the telephone apparatus on the calling side to the telephone apparatus on the called side to the given communication apparatus when it is determined that the presence of the incoming call is reported to the given communication apparatus.

17. A computer-readable recording medium which stores a computer-executable computer program for causing a computer to control communication between telephone apparatuses performing the communication with each other via a network, the computer program comprising instructions for causing the computer to execute:
sensing a call originated from one of the telephone apparatuses via the network;
detecting a telephone apparatus on a calling side and a telephone apparatus on a called side when the call is sensed;
detecting a state of the detected telephone apparatus on the called side;
determining whether or not presence of an incoming call from the telephone apparatus on the calling side to the telephone apparatus on the called side is reported to a given communication apparatus on a basis of the detected state; and
sending an instruction to output the presence of the incoming call from the telephone apparatus on the calling side to the telephone apparatus on the called side to the given communication apparatus when it is determined that the presence of the incoming call is reported to the given communication apparatus.
